(19) United States
(12) Patent Application Publication
(10) Pub. No.: US 2024/0400784 A1
(43) Pub. Date: Dec. 5, 2024

(54) Method for Screening Solvent for Extracting Polyvinyl Chloride, Method for Recycling Waste, Recycled Polyvinyl Chloride, and Composition

(71) Applicant: LG Chem, Ltd., Seoul (KR)

(72) Inventors: Seungha Kim, Daejeon (KR); Eunbyeol Ko, Daejeon (KR); Kyoung Hoon Kim, Daejeon (KR); Hyung Sop Kim, Daejeon (KR); Gahyeon Lee, Daejeon (KR); Seung Yong Lee, Daejeon (KR); Yoonsun Jang, Daejeon (KR); Kyeong Hwan Han, Daejeon (KR)

(73) Assignee: LG Chem, Ltd., Seoul (KR)

(21) Appl. No.: 18/687,499

(22) PCT Filed: Sep. 2, 2022
(86) PCT No.: PCT/KR2022/013227

§ 371 Date: Feb. 29, 2024

(30) Foreign Application Priority Data
Sep. 3, 2021 (KR) 10-2021-0117886
Sep. 3, 2021 (KR) 10-2021-01178888
Sep. 1, 2022 (KR) 10-2022-0110821

(51) Int. Cl. C08J 11/08

(52) U.S. Cl. CPC C08J 11/08; C08J 2327/06

(57) ABSTRACT

A method for screening a solvent for extracting polyvinyl chloride (PVC) from waste using the following Equation 1:

$$PVC swelling score = {x}_{1} Dipole + {x}_{2} Asphericity + {x}_{3} dH + {x}_{4} Polar Surface Area$$

where x₁, x₂, x₃, and x₄ are each a real number from 0 to 5, Dipole is a dipole moment of solvent molecules, Asphericity is an asphericity of the solvent molecules, dH is a Hansen solubility parameter for a hydrogen bonding of the solvent molecules, and Polar Surface Area is a fractional polar surface area. A method for recycling waste is also provided. Additionally, a recycled polyvinyl chloride and a recycled composition are provided.

### CROSS-REFERENCE TO RELATED APPLICATIONS

This application is a national phase entry under 35 U.S.C. § 371 of International Application No. PCT/KR2022/013227 filed on Sep. 2, 2022, which claims priority to Korean Patent Application Nos. 10-2021-0117888, 10-2021-0117886, and 10-2022-0110821 filed on Sep. 3, 2021, Sep. 3, 2021, and Sep. 1, 2022, respectively, the entire contents of which are incorporated herein by reference.

### TECHNICAL FIELD

The present specification relates to a method for screening a solvent for extracting polyvinyl chloride, a method for recycling waste, recycled polyvinyl chloride, and a recycled composition.

### BACKGROUND ART

Since plastic can be molded into various shapes by heat or pressure, and the quality of the material is getting better and better, things in everyday life are being replaced with plastic, and new things using the same are being developed.

Since plastics are convenient and easy to use, demand for products made of plastics, such as plastic bags, PET bottles, disposable items, packaging products, and electronic products, is gradually increasing all over the world.

Such used and discarded plastics are either incinerated or landfilled. In the case of incineration, many contaminants harmful to the human body are discharged, so it is preferable that the discarded plastics are landfilled rather than incinerated.

However, it takes a long time to naturally decompose most plastics after disposal, and the amount of plastics that end up in landfills is substantial, so interest in recycling plastics is increasing.

Among plastics, polyvinyl chloride (PVC) has been widely used in building materials (pipes, window frames, and the like), electric wire coatings, synthetic leather, rubber tubs, hoses, flooring materials, packing materials, medical sap bags, toys, and the like. Various methods for recycling PVC from waste including PVC and materials capable of minimizing damage to humans and the environment during the recycling process need to be explored.

### Technical Problem

The present specification provides a method for screening a solvent for extracting polyvinyl chloride, a method for recycling waste, recycled polyvinyl chloride, and a recycled composition.

### Technical Solution

An exemplary embodiment of the present specification provides a method for screening a solvent for extracting polyvinyl chloride. The method includes screening a solvent for extracting polyvinyl chloride from waste including the polyvinyl chloride using the following Equation 1.

$$PVC swelling score = {x}_{1} Dipole + {x}_{2} Asphericity + {x}_{3} dH + {x}_{4} Polar Surface Area \qquad [ Equation 1 ]$$

In Equation 1,
x₁, x₂, x₃, and x₄ are each a real number from 0 to 5,
Dipole is the dipole moment of solvent molecules,
Asphericity is the asphericity of solvent molecules,
dH is the Hansen solubility parameter for the hydrogen bonding of solvent molecules, and
Polar Surface Area is a fractional polar surface area.

Another exemplary embodiment of the present specification provides a method for recycling waste including polyvinyl chloride. The method includes screening a solvent for extracting polyvinyl chloride using the above-described method for screening the solvent and extracting polyvinyl chloride from waste including the polyvinyl chloride using the screened solvent.

Still another exemplary embodiment of the present specification provides recycled polyvinyl chloride extracted from waste including polyvinyl chloride using a solvent screened by the above-described method for screening the solvent.

Yet another exemplary embodiment of the present specification provides a waste polyvinyl chloride recycled composition including polyvinyl chloride extracted from waste including polyvinyl chloride, any one good solvent of solvents with a PVC swelling score value of 0 or less according to the following Equation 1, and any one non-solvent of solvents with a PVC swelling score value of more than 0 according to the following Equation 1.

$$PVC swelling score = {x}_{1} Dipole + {x}_{2} Asphericity + {x}_{3} dH + {x}_{4} Polar Surface Area \qquad [ Equation 1 ]$$

In Equation 1,
x₁, x₂, x₃, and x₄ are each a real number from 0 to 5, Dipole is the dipole moment of solvent molecules, Asphericity is the asphericity of solvent molecules, dH is the Hansen solubility parameter for the hydrogen bonding of solvent molecules, and Polar Surface Area is a fractional polar surface area.

### Advantageous Effects

According to an exemplary embodiment of the present specification, it is possible to find various solvents capable of being used in the process of extracting polyvinyl chloride from waste including polyvinyl chloride.

According to another exemplary embodiment of the present specification, it is possible to find various good solvent-non-solvent combinations suitable for the process of extracting polyvinyl chloride from waste including polyvinyl chloride.

### BRIEF DESCRIPTION OF DRAWINGS

FIG. 1 is a graph showing PVC swelling score values calculated by Equation 1 according to the present specification.

FIG. 2 is a graph showing the relationship between the PVC swelling score value calculated by Equation 1 according to the present specification and the swelling ratio Log value.

### DETAILED DESCRIPTION

Hereinafter, the present specification will be described in detail.

The present specification has been made in an effort to provide a parameter capable of classifying and evaluating a solvent available for extracting polyvinyl chloride (PVC) from waste by predicting the solvent. Through this, a new solvent capable of extracting PVC may be discovered. Here, the solvent capable of extracting PVC means all solvents used for extracting PVC from waste, and specifically, may include not only a good solvent that has high solubility in PVC and thus can dissolve PVC from waste, but also a non-solvent that can obtain PVC by precipitating PVC from a good solvent in which PVC is dissolved. Further, one or more solvents can be mixed and used for one role. For example, a single solvent may be used as a good solvent, and a mixture of two or more solvents may be used as the good solvent, and in this case, in consideration of a mixing ratio of each solvent in a mixed solvent, that is, a weight fraction, a PVC swelling score value is calculated by substituting the weight fraction into Equation 1 to be described below.

An exemplary embodiment of the present specification provides a method for screening a solvent for extracting polyvinyl chloride, the method including screening a solvent for extracting polyvinyl chloride from waste including the polyvinyl chloride using the following Equation 1.

$$PVC swelling score = {x}_{1} Dipole + {x}_{2} Asphericity + {x}_{3} dH + {x}_{4} Polar Surface Area \qquad [ Equation 1 ]$$

In Equation 1,
x₁, x₂, x₃, and x₄ are each a real number from 0 to 5,
Dipole is the dipole moment of solvent molecules,
Asphericity is the asphericity of solvent molecules,
dH is the Hansen solubility parameter for the hydrogen bonding of solvent molecules, and
Polar Surface Area is a fractional polar surface area.

In an exemplary embodiment of the present specification, the affinity between PVC and a solvent is calculated using data of solvent dipole moment, asphericity, Hansen solubility parameter, and fractional polar surface area, and based on the calculated results, it is possible to classify a good solvent that mixes well with PVC, that is, a solvent capable of separating PVC from waste, and a non-solvent that does not mix well with PVC, that is, a solvent capable of precipitating PVC from a solvent in which PVC is dissolved.

In an exemplary embodiment of the present specification, Equation 1 expressed PVC solubility in solvents using dipole moment, asphericity, dH and polar surface area. When solvent molecules are polar, the interaction with PVC increases, and the more the solvent molecules are spherical, the more the solvent molecules are compressed to the same mass, so the solvent molecules can penetrate well between PVC chains, thereby increasing the solubility. The hydrogen bonding contribution of the Hansen solubility parameter reflects that solubility increases when increasing the hydrogen bonding between solvent molecules and PVC. The polar surface area indicates whether the polar part is exposed to the surface and thus interacts more easily with the PVC polymer.

In an exemplary embodiment of the present specification, Equation 1 means a solubility score in consideration of factors capable of determining the solubility between PVC and a solvent along with the variables of experimental conditions such as temperature. The value of Equation 1 decreases as the solubility in PVC increases.

In an exemplary embodiment of the present specification, through the value of Equation 1, a good solvent and a non-solvent may be distinguished based on a reference value for distinguishing the good solvent and the non-solvent of 3, 2.5, 2, 1.5, 1, 0.5, 0, −0.5, −1, −1.5, −2, −2.5, or −3. Specifically, when the value is the reference value or less, the solvent may be determined as a good solvent, and when the value is more than the reference value, the solvent may be determined as a non-solvent.

In Equation 1 of an exemplary embodiment of the present specification, Dipole means the dipole moment of solvent molecules, can be calculated with a general descriptor calculation program, and can be calculated using Dragon, Mordred, PaDEL-Descriptor, and the like.

In Equation 1 of an exemplary embodiment of the present specification, asphericity indicates whether the solvent molecules are structurally close to spheres, can be calculated with a general descriptor calculation program, and can be calculated using Dragon, Mordred, PaDEL-Descriptor, and the like.

In Equation 1 of an exemplary embodiment of the present specification, dH means the hydrogen bonding index of the Hansen solubility parameter, and a predicted value can be obtained through a program called Hansen Solubility Parameter.

In Equation 1 of an exemplary embodiment of the present specification, Polar Surface Area is a fractional polar surface area, and indicates the degree of exposure of polar parts on the surface, and the greater the degree of polar exposure to the surface, the easier the interaction with PVC polymer. Polar Surface Area can be calculated in CORINA and Discovery Studio of BIOVIA.

The values of x₁, x₂, x₃, and x₄ can be adjusted according to process conditions such as temperature and pressure. As the temperature increases or the pressure decreases, the diffusion rate of solvent molecules increases, and accordingly, the diffusion rate may increase because x₂ (spherical shape of solvent molecules) associated with diffusion may increase because x₂ is more dependent on the temperature and the pressure, and as the temperature decreases or the pressure increases, the interaction with PVC becomes more important than the solvent diffusion rate, so the parameters of x₁, x₃, and x₄ need to be increased.

In an exemplary embodiment of the present specification, x₁ is a control variable determined by process conditions such as temperature and pressure. x₁ is a real number from 0 to 5, specifically a real number from 0 to 3, and more specifically a real number from 0 to 2, and may be preferably 1.5. Through x₁, it is possible to consider the interaction between PVC and solvent molecules with importance, and when process conditions are changed, the x₁ value is increased such that the effect of the dipole parameter value in Equation 1 is increased if the contribution of interaction between PVC and solvent molecules increases, and the x₁ value may be decreased such that the effect of the dipole parameter value in Equation 1 is reduced if the contribution of interaction between PVC and solvent molecules decreases. For example, when the temperature is high or pressure is lowered in process conditions, the diffusion of molecules increases to reduce the contribution of interaction between PVC and solvent molecules, so the temperature and pressure need to be adjusted through x₁ such that the effect of the dipole parameter value in Equation 1 is decreased.

In an exemplary embodiment of the present specification, x₂ is a control variable determined by process conditions such as temperature and pressure. x₂ is a real number from 0 to 5, specifically a real number from 0 to 3, and more specifically a real number from 0 to 2, and may be preferably 1.5.

In an exemplary embodiment of the present specification, x₂ is a variable related to asphericity, and asphericity means the size of solvent molecules per unit mass, and the more spherical the solvent molecules, the more easily the solvent molecules penetrate PVC. When process conditions are changed, the x₂ value is increased such that the effect of the asphericity parameter value in Equation 1 is increased if the contribution of PVC and molecules to diffusion increases, and the x₂ value may be decreased such that the effect of the asphericity parameter value in Equation 1 is reduced if the contribution of PVC and molecules to diffusion decreases. For example, when the temperature is high or pressure is lowered in process conditions, the diffusion of molecules increases, so the solvent molecular movement is active, and this makes it easier for the solvent molecules to penetrate the PVC, making the molecular diffusion contribution more important, so the temperature and pressure need to be adjusted through x₂ such that the effect of the asphericity value in Equation 1 increases.

In an exemplary embodiment of the present specification, x₃ is a control variable determined by process conditions such as temperature and pressure. x₃ is a real number from 0 to 5, specifically a real number from 0 to 3, and more specifically a real number from 0 to 1, and may be preferably 0.5. Through x₃, it is possible to consider the hydrogen bonding between PVC and solvent molecules with importance, and when process conditions are changed, the diffusion of molecules increases, so that x₃ value is decreased such that the effect of the dH parameter value in Equation 1 is decreased if the contribution of hydrogen bonding between PVC and solvent molecules decreases, and the x₃ value may be increased such that the effect of the dH parameter value in Equation 1 is increased if the contribution of hydrogen bonding between PVC and solvent molecules increases. For example, when the temperature is high or pressure is lowered in process conditions, the diffusion of molecules increases to reduce the contribution of hydrogen bonding between PVC and solvent molecules, so the temperature and pressure need to be adjusted through x₃ such that the effect of the dH parameter value is decreased.

In an exemplary embodiment of the present specification, x₄ is a control variable determined by process conditions such as temperature and pressure. x₄ is a real number from 0 to 5, specifically a real number from 0 to 3, and more specifically a real number from 0 to 1, and may be preferably 0.25. Through x₄, it is possible to consider the interaction between PVC and solvent molecules with importance, and when process conditions are changed, the diffusion of molecules increases, so that x₄ value is decreased such that the effect of the polar surface area parameter value in Equation 1 is decreased if the contribution of interaction between PVC and solvent molecules decreases, and the x₄ value may be increased such that the effect of the polar surface area parameter value in Equation 1 is increased if the contribution of interaction between PVC and solvent molecules increases. For example, when the temperature is high or pressure is lowered in process conditions, the diffusion of molecules increases to reduce the contribution of interaction between PVC and solvent molecules, so the temperature and pressure need to be adjusted through x₄ such that the effect of the polar surface area parameter value is decreased.

In an exemplary embodiment of the present specification, a solvent with a PVC swelling score value of 0 or less according to Equation 1 may be determined to be a good solvent for polyvinyl chloride. In this case, the good solvent means a solvent capable of dissolving polyvinyl chloride, and is a solvent capable of dissolving and extracting polyvinyl chloride from the waste.

In an exemplary embodiment of the present specification, when x₁ is 1.5, x₂ is 1.5, x₃ is 0.5, and x₄ is 0.25, a solvent with a PVC swelling score value of 0 or less according to Equation 1 may be determined to be a good solvent for polyvinyl chloride.

In an exemplary embodiment of the present specification, a solvent with a PVC swelling score value of more than 0 according to Equation 1 may be determined to be a non-solvent for polyvinyl chloride. In this case, the non-solvent means a solvent that has low solubility in polyvinyl chloride, and is a solvent that can be used when polyvinyl chloride is precipitated from an extracted polyvinyl chloride solution.

In an exemplary embodiment of the present specification, when x₁ is 1.5, x₂ is 1.5, x₃ is 0.5, and x₄ is 0.25, a solvent with a PVC swelling score value of more than 0 according to Equation 1 may be determined to be a non-solvent for polyvinyl chloride.

In another exemplary embodiment of the present specification, it is possible to further include selecting any one solvent of solvents with a PVC swelling score value of 0 or less according to Equation 1 as a good solvent for polyvinyl chloride and selecting any one solvent of solvents with a PVC swelling score value of more than 0 according to Equation 1 as a non-solvent for polyvinyl chloride.

In an exemplary embodiment of the present specification, a difference between the PVC swelling score value of the good solvent and the PVC swelling score value of the non-solvent may be 0.1 or more, 0.2 or more, 0.3 or more, 0.4 or more, 0.5 or more, 0.6 or more, 0.7 or more, 0.8 or more, 0.9 or more, 1 or more, 1.1 or more, 1.2 or more, 1.3 or more, 1.4 or more, 1.5 or more, 1.6 or more, 1.7 or more, 1.8 or more, 1.9 or more, 2 or more, 2.1 or more, 2.2 or more, 2.3 or more, 2.4 or more, 2.5 or more, 2.6 or more, 2.7 or more, 2.8 or more, 2.9 or more, 3 or more, 3.1 or more, 3.2 or more, 3.3 or more, 3.4 or more, 3.5 or more, 3.6 or more, 3.7 or more, 3.8 or more, 3.9 or more, 4 or more, 4.1 or more, 4.2 or more, 4.3 or more, 4.4 or more, 4.5 or more, 4.6 or more, 4.7 or more, 4.8 or more, 4.9 or more, 5 or more, 5.1 or more, 5.2 or more, 5.3 or more, 5.4 or more, 5.5 or more, 5.6 or more, 5.7 or more, 5.8 or more, 5.9 or more, 6 or more, 6.1 or more, 6.2 or more, 6.3 or more, 6.4 or more, 6.5 or more, 6.6 or more, 6.7 or more, 6.8 or more, 6.9 or more, 7 or more, 7.1 or more, 7.2 or more, 7.3 or more, 7.4 or more, 7.5 or more, 7.6 or more, 7.7 or more, 7.8 or more, 7.9 or more, 8 or more, 8.1 or more, 8.2 or more, 8.3 or more, 8.4 or more, 8.5 or more, 8.6 or more, 8.7 or more, 8.8 or more, 8.9 or more, 9 or more, 9.1 or more, 9.2 or more, 9.3 or more, 9.4 or more, 9.5 or more, 9.6 or more, 9.7 or more, 9.8 or more, 9.9 or more, or 10 or more.

In an exemplary embodiment of the present specification, a difference between the PVC swelling score value of the good solvent and the PVC swelling score value of the non-solvent may be 1.5 or more.

In an exemplary embodiment of the present specification, the good solvent may have a boiling point of 70° C. or more, 71° C. or more, 72° C. or more, 73° C. or more, 74° C. or more, 75° C. or more, 76° C. or more, 77° C. or more, 78° C. or more, 79° C. or more, 80° C. or more, 81° C. or more, 82° C. or more, 83° C. or more, 84° C. or more, 85° C. or more, 86° C. or more, 87° C. or more, 88° C. or more, 89° C. or more, 90° C. or more, 95° C. or more, or 100° C. or more. In this case, when heating is required in the process, the good solvent has a boiling point higher than the heating temperature, so it is advantageous because there is no loss of good solvent due to heating, and the solvent is easily treated because the volatility is adjusted to some extent. In this case, the upper limit of the boiling point of the good solvent is not particularly limited, but when the boiling point is too high, the energy required for drying may increase during the drying process after the extraction of PVC is completed, so a good solvent may be selected in consideration of process costs. For example, the good solvent may have a boiling point of 400° C. or less, 350° C. or less, or 300° C. or less.

Another exemplary embodiment of the present specification provides a method for recycling waste including polyvinyl chloride, the method including screening a solvent for extracting polyvinyl chloride using the above-described method for screening the solvent and extracting polyvinyl chloride from waste including the polyvinyl chloride using the screened solvent.

In the present specification, the description of the screening step in the waste recycling method may reference the above-described method for screening a solvent for extracting PVC.

In an exemplary embodiment of the present specification, the extracting of the polyvinyl chloride may include a dissolution process of bringing waste including the polyvinyl chloride into contact with a good solvent with a PVC swelling score value of 0 or less according to Equation 1 and obtaining a polyvinyl chloride solution by dissolving polyvinyl chloride in the waste in the good solvent.

Still another exemplary embodiment of the present specification provides a method for recycling waste including polyvinyl chloride, the method including selecting each one of a good solvent and a non-solvent for extracting polyvinyl chloride using the above-described method for screening a solvent, bringing waste including the polyvinyl chloride into contact with the good solvent and obtaining a polyvinyl chloride solution by dissolving polyvinyl chloride in the waste in the good solvent (hereinafter, referred to as a dissolution process), and precipitating polyvinyl chloride from the solution by bringing the solution into contact with the non-solvent (hereinafter, referred to as a precipitation process).

In an exemplary embodiment of the present specification, the extracting of the polyvinyl chloride may include a dissolution process of bringing waste including the polyvinyl chloride into contact with any one good solvent of solvents with a PVC swelling score value of 0 or less according to Equation 1 and obtaining a polyvinyl chloride solution by dissolving polyvinyl chloride in the waste in the good solvent, and a precipitation process of precipitating polyvinyl chloride from the solution by bringing the solution into contact with any one non-solvent of solvents with a PVC swelling score value of more than 0 according to Equation 1.

In an exemplary embodiment of the present specification, the extracting of the polyvinyl chloride may further include a separation process of separating a solid material from a polyvinyl chloride solution obtained by the dissolution process. In this case, the solid material is a solid that is not dissolved in a good solvent of polyvinyl chloride, and corresponds to impurities.

In an exemplary embodiment of the present specification, the extracting of the polyvinyl chloride may further include a rinsing process of rinsing polyvinyl chloride precipitated by the precipitation process.

In an exemplary embodiment of the present specification, the extracting of the polyvinyl chloride may further include a drying process of drying polyvinyl chloride precipitated by the precipitation process.

Still another exemplary embodiment of the present specification provides recycled polyvinyl chloride extracted from waste including polyvinyl chloride using a solvent screened by the above-described method for screening the solvent.

Yet another exemplary embodiment of the present specification provides a waste polyvinyl chloride recycled composition including polyvinyl chloride extracted from waste including polyvinyl chloride, any one good solvent of solvents with a PVC swelling score value of 0 or less according to the following Equation 1, and any one non-solvent of solvents with a PVC swelling score value of more than 0 according to the following Equation 1.

$$PVC swelling score = {x}_{1} Dipole + {x}_{2} Asphericity + {x}_{3} dH + {x}_{4} Polar Surface Area \qquad [ Equation 1 ]$$

In Equation 1,
Dipole is the dipole moment of solvent molecules, Asphericity is the asphericity of solvent molecules, dH is the Hansen solubility parameter for the hydrogen bonding of solvent molecules, and Polar Surface Area is a fractional polar surface area.

Here, for the description on Equation 1, the above-described description is referenced to avoid duplication.

In an exemplary embodiment of the present specification, a waste polyvinyl chloride recycled composition means a state including all of polyvinyl chloride extracted by the good solvent from waste including polyvinyl chloride, a good solvent used during the extraction of polyvinyl chloride, and a non-solvent that separates and precipitates the extracted polyvinyl chloride from the good solvent. For polyvinyl chloride extracted according to the ratio of the good solvent and the non-solvent, polyvinyl chloride dissolved in the good solvent and precipitated polyvinyl chloride may coexist, or most of polyvinyl chloride may be precipitated and settled in a solid state.

In an exemplary embodiment of the present specification, when the weight of the good solvent in the waste polyvinyl chloride recycled composition is set to 100, the content of the non-solvent is at least 100 parts by weight, and the solute may be precipitated by adding the non-solvent in an amount, which is equal to or more than the weight of the good solvent. The higher the content of non-solvent, the easier it is to precipitate the solute and the process time can be shortened, but in order to increase the purity in the solute, it is preferred to adjust the content of the non-solvent in consideration of the appropriate precipitation rate and the particle size of the precipitated solute.

In an exemplary embodiment of the present specification, when the weight of the good solvent is set to 100, the content of the non-solvent may be 100 parts by weight or more, 150 parts by weight or more, 200 parts by weight or more, 250 parts by weight or more, 300 parts by weight or more, 350 parts by weight or more, 400 parts by weight or more, 450 parts by weight or more or 500 parts by weight or more, 1000 parts by weight or less, 900 parts by weight or less, 800 parts by weight or less, 700 parts by weight or less, or 600 parts by weight or less.

In an exemplary embodiment of the present specification, the content of the good solvent is not particularly limited as long as the PVC in the waste can be dissolved. When the weight of the waste including waste polyvinyl chloride is set to 100, the content of the good solvent is at least 100 parts by weight, and the solute may be precipitated by adding the good solvent in an amount, which is equal to or more than the weight of the waste.

In an exemplary embodiment of the present specification, when the weight of the waste including waste polyvinyl chloride is set to 100, the content of the good solvent may be 100 parts by weight or more, 150 parts by weight or more, 200 parts by weight or more, 250 parts by weight or more, 300 parts by weight or more, 350 parts by weight or more, 400 parts by weight or more, 450 parts by weight or more or 500 parts by weight or more, 1000 parts by weight or less, 900 parts by weight or less, 800 parts by weight or less, 700 parts by weight or less, or 600 parts by weight or less.

In an exemplary embodiment of the present specification, the good solvent and the non-solvent are each independently any one of an alcohol-based solvent, a ketone-based solvent, an ester-based solvent, an ether-based solvent, a polar nonprotic solvent, a hydrocarbon solvent, or a halogen-containing solvent.

In an exemplary embodiment of the present specification, the good solvent is any one of an alcohol-based solvent, a ketone-based solvent, an ester-based solvent, an ether-based solvent, a polar nonprotic solvent, a hydrocarbon solvent, or a halogen-containing solvent.

In an exemplary embodiment of the present specification, the good solvent has a PVC swelling score value of 0 or less according to Equation 1, and is selected in consideration of the difference in solubility for between the non-solvent and polyvinyl chloride used together. The good solvent may be any one selected among n,n-dimethylacetamide, cyclopentanone, 2-pentanone, dioxane, nitrobenzene, ethylacetate, benzene, trichloroethylene, 1,2-dichloroethane, chloroform, cyclohexanone, tetrahydrofuran, 2-butanone, acetone, 4-methylpentan-2-one, 1,2,3-propanetrioltrinitrate, tetramethylenesulfoxide, 1-piperidinecarboxaldehyde, 1-acetylpiperidine, n-methyl-2-pyrrolidinone, 1,4-dimethylpyrrolidone, 1,3-dimethyl-2-imidazolidinone, 1,5-dimethylpyrrolidone, hexamethylphosphoramide, dimethylpropyleneurea, 1-ethyl-2-pyrrolidone, 1,3-dimethylpyrrolidone, 4-acetylmorpholine, 1-[ethoxy(methyl)phosphoryl]methylpiperidine, n,n-dimethylpropanamide, tributylphosphineoxide, 1-propyl-2-pyrrolidinone, n-isopropylpyrrolidone, n,n,4-trimethylbenzamide, n-methyl-o-acetotoluidide, 2-cyclohexen-1-one, n,n,3-trimethylbenzamide, n,n-dimethylbenzamide, trimethylenesulfide, n,n,2-trimethylbenzamide, 1,3-dioxane, tetramethylurea, 2-azacyclooctanone, 4-methyl-1-propyl-2-pyrrolidinone, 5-methyl-1-propyl-2-pyrrolidinone, n,n-diethylacetamide, 1,3-propanedithiol, 4,5-dihydro-2-methylthiazole, pyrrolidine, 3-methoxy-n,n-dimethylpropanamide, 4-fluoro-n,n-dimethylbenzamide, cycloheptanone, 1-morpholinopentan-1-one, 3-methylcyclohexanone, n,n-dimethylbutanamide, caprolactam, tetrahydrothiophene, 2-methoxy-n,n-dimethylbenzamide, dimethylformamide, 1,2-ethanedithiol, 1,4,7,10-tetraoxacyclododecane, ethyl 1,3-dimethyl-2-oxopyrrolidine-3-carboxylate, 1-(4-methylpiperidyl)butan-1-one, 2-methylcyclohexanone, 1-(2,6-dimethylmorpholin-4-yl)butan-1-one, n,n-diethylformamide, 4-(propan-2-yl)phenyldimethylcarbamate, n,n-dimethyl-3-phenylpropanamide, n-(1-methyl-2-methoxyethyl)-n-chloroacetyl-2-ethyl-6-methylaniline, dichloroacetylchloride, n,n-diethyl-3-(2-methyl-1,3-dioxolan-2-yl)propanamide, n-acetylcaprolactam, d-camphor, n-methylformanilide, ethyl n-acetyl-n-ethyl-beta-alaninate, (2,5-dimethoxyphenyl)acetaldehyde, 4-methylcyclohexanone, 2,6-dimethyl-2,5-cyclohexadiene-1,4-dione, 4-vinylcyclohexene dioxide, nicotine, 2-methylcyclopentanone, dimethylveronal, diethyl(trichloromethyl)phosphonate, 3-methyl-6-isopropylidenecyclohexanone, 1-heptanoyl-4-methylpiperazine, n,n-diethyl-4-oxopentanamide, n-ethyl-n-phenylacetamide, dimethyldisulfide, 4,6-dimethylpyrimidine, 1,4-oxathiane, n-sec-butylpyrrolidone, 1-(4-methylpiperidin-1-yl)pentan-1-one, 1-butyl-5-methyl-2-pyrrolidinone, 3-methyl-2-oxazolidone, n,n-dimethyl-4-(propan-2-yl)benzamide, 2,5-dimethylpyrazine, mesitenelactone, propyl 4-(dimethylamino)-4-oxobutanoate, diethyldimethylamidophosphate, isophorone, n,n-dimethyl 4-methoxybenzamide, 1,2,3,5-tetramethoxybenzene, 3,4,5-trimethoxytoluene, caprolactone, 3-methyl-piperidin-2-one, 2-ethylhexylsalicylate, ethyl 3-ethyl-2-oxooxolane-3-carboxylate, 1-ethyl-3,5,7-trimethyl-1,3-dihydro-azepin-2-one, dimethylisosorbide, cyclotenebutyrate, ethyl 2-(2-methoxyphenoxy)acetate, cyrene, 2,4,4-trimethyl-6-oxocyclohex-1-en-1-yl acetate, 1,2-benzodihydropyrone, tripropyleneglycolethyletherisomer, 3,4-dimethoxypropiophenone, methylaminoacetaldehydedimethylacetal, methyl 2,6-dimethoxybenzoate, 1,3-dimethyl-1,2,3,4-tetrahydro-4-quinolinone, ethyl 3,5-dimethoxybenzoate, 4-methoxybenzaldehyde, ethyl (4-methylphenoxy)acetate, 2,3,4-trimethoxyacetophenone, ethylimidazole, methyl 2-oxocyclooctanecarboxylate, ethyl 2-methyl-4-oxocyclohex-2-enecarboxylate, 2′,5′-dimethoxyacetophenone, isobutylformate, ethyl 2-(2,6-dimethylphenoxy)acetate, ethyl 2-(benzyloxy)acetate, hexylacetoacetate, diethylglutarate, 4-carbethoxy-2-ethyl-3-methyl-2-cyclohexen-1-one, nepetalactone, tripropyleneglycolbutylether, ethyl 5,5-dimethyl-2-oxofuran-3-carboxylate, 2-ethoxybenzaldehyde, methyl-2,4-dimethoxybenzoate, 5,5-diethyl-4-methoxyfuran-2(5H)-one, ethyl 4,6-dimethyl-2-oxo-3,4-dihydro-2h-pyran-5-carboxylate, ethyl 4-phenoxybutanoate, 2,5-dimethoxypropiophenone, ethyl 5,5-dimethyl-2-oxotetrahydrofuran-3-carboxylate, ethyl 3-(5-oxotetrahydrofuran-2-yl)propanoate, benzylsalicylate, n,n-diethyl-4-methyl-4h-pyridine-1-carboxamide, p-tolylacetonitrile, 5-methyl-2(3h)-furanone, 1-methyl-2-(3-pyridyl)pyrrole, formicacidpentylester, ethyl 4-(dimethylamino)benzoate, n-butylacetamide, 4-methylbenzaldehyde, 3′,4′-dimethoxyisobutyrophenone, benzaldehyde, 1,2,4-triethoxybenzene, isobutylphenoxyacetate, m-dimethoxybenzene, 3-oxobutanoicacid-1-methylethylester, ethyl-2-(cyclohexylmethyl)-3-oxobutanoate, 5-ethyldihydro-2 (3h)-furanone, 2-isopropyl-n,2,3-trimethylbutyramide, 4-(4-methylpiperidino)pyridine, 3-oxaspiro-undecan-2-one, formicacidhexylester, methyl 2,2-dimethyl-4,6-dioxocyclohexanecarboxylate, ethyl 6-ethyl-2-methyl-4-oxocyclohex-2-ene-1-carboxylate, benzenepropanenitrile, 4,4-dimethyl-5,6,7,8-tetrahydro-1H-isochromen-3-one, ethyl 2,6-dimethyl-4-oxocyclohex-2-enecarboxylate, n,n-dimethyloctanamide, 1-(2,5-dimethylpyrrolidin-1-yl)pentan-1-one, gamma-butyrolactone, t-butylacetoacetate, 4-(methoxymethyl)anisole, mintlactone, 2-methoxyethylacetoacetate, p-(2,2-dimethoxyethoxy)anisole, 1-(1-ethylpropyl)-2-pyrrolizinone, 2,5-dimethoxytetrahydrofuran, 2-acetoxy-1-ethoxypropane, 1,3-dimethyl-4-ethylcarbostyril, 1-(4-methoxyphenoxy)acetone, glycerol tripropionate, 3-dimethylaminoanisole, 2,4-dimethylbenzaldehyde, paraldehyde, glycerol tributyrate, 2,3,4,5-tetramethoxytoluene, 1,3,3-trimethyl-2h-quinolin-4-one, 3-cyclohexene-1-carboxaldehyde, isobutylsalicylate, 2-(1-methylpropyl)phenyl methylcarbamate, (2,2-diethoxyethoxy)benzene, methyl 3-(5-oxooxolan-2-yl)propanoate, 4-acetoxy-2,5-dimethyl-3(2h)-furanone, 3-ethylchroman-2-one, ethyl 3-cyclohexyl-3-oxopropanoate, 1-propyl-2(1h)-pyridinone, 7-methyl-4,4a,5,6-tetrahydro-3H-naphthalen-2-one, 1-(3,5-dimethylphenoxy)propan-2-one, ethyl 3-(2,5,5-trimethyl-1,3-dioxan-2-yl)propanoate, 1-tetralone, 4-methyl-3-penten-2-one, 1-tert-butylpyrrolidin-2-one, methyl 2-(4-(tert-butyl)phenoxy)acetate, 2,6,10,10-tetramethyl-1-oxaspiro(4,5)deca-2,6-dien-8-one, ethyl 4-ethoxybenzoate, maltyl isobutyrate, 4-methyl-1,3-dioxane, 2-acetylpyridine, 1,4-diethoxybenzene, 1-(2,2-diethoxyethoxy)-4-methylbenzene, cyclohexyl lactone, 2-(2-butoxyethoxy)ethyl acetate, n-methylbenzamide, 3-acetyl-5-propyldihydrofuran-2(3h)-one, 2,2-diethoxyethoxymethylbenzene, n-methyl-m-tolylcarbamate, ethylene glycol dibutyrate, 4-cyano-2-fluorobenzoyl chloride, 3,6-dimethyl-2,3,3a,4,5,7a-hexahydro-1-benzofuran-2-one, ethyl 2-(2-oxocyclohexyl)acetate, 4-(2-acetoxyethoxy)toluene, 4-(2,5-dimethylpyrrol-1-yl)-2,6-dimethylmorpholine, 1-butylpyridin-2(1h)-one, n,n-dimethyldecanamid, valeraldehyde, 2-(3-pyridyl)piperidine, 4-methoxypropiophenone, 4-tert-butyl-n,n-dimethylbenzamide, acetylacetone, ethyl 2-methyl-2-phenoxypropanoate, ethyl 2-acetyl-5-oxohexanoate, n-sec-isopentylpyrrolidone, 4-methyl-1-tetralone, 2-butoxyethanolacetate, isobutyric anhydride, n-hexyl-2-pyrrolidinone, 3-benzyl-2,4-pentanedione, ethyl 5-oxodecanoate, methyl 2-hexyl-3-oxocyclopentanecarboxylate, 8-ethyl-1-oxaspiro[4.5]decan-2-one, n,n′-dibutylethyleneurea, methyl 3-oxododecanoate, 3-methyl-5-isopropyl-4-carbethoxy-2-cyclohexene-1-one, 6-pentyl-2h-pyran-2-one, m-methoxyacetophenone, benzisoxazole, n,n-diethylnicotinamide, ethyl 3-(2-oxocyclohexyl)propanoate, propyl 4-ethoxybenzoate, 5-butyl-5-ethyltetrahydro-2h-pyran-2-one, ethyl 2-oxo-1-propylcyclohexanecarboxylate, 2-propoxyethylacetate, dimethyl 2-methylglutarate, o-methylcorypalline, 1-pentylimidazole, n-formylmorpholine, methyl 2-butoxybenzoate, 7-butyloxepan-2-one, propanoic anhydride, acetophenone, 1-(3-methylpiperidin-1-yl)pentan-1-one, 1-butyl-2-methyl-imidazole, anisaldehyd diethyl acetal, 1-(2-methylpiperidin-1-yl)pentan-1-one, 5-butyl-5-ethyloxolan-2-one, 2,4,6-trimethylbenzaldehyde, n,n-diethylcyclohex-3-ene-1-carboxamide, butan-2-yl 4-methoxybenzoate, propylene glycol alpha methylbenzyl ether, 5-(benzyloxy)pentan-2-one, n,n-dimethyldodecanamide, n,n-diethyl-m-toluamide, (s)-dihydrobovolide, 3,4-dihydro-3-oxoedulan, butyl 2-methoxybenzoate, 7-cyclohexyloxepan-2-one, dimethyl 1,4-cyclohexanedicarboxylate, delta-decalactone, ethyl 2,5-dimethylphenoxyisobutyrate, 4a,8-dimethyl-3,4,5,6,7,8-hexahydronaphthalen-2-one, 5-hydroxy-2-decenoic acid lactone, ethyl 2-(2-oxooxolan-3-yl)acetate, methyloctalacton, 3-pentanone, 2,4-diacetylfuran, 2′-pentyloxyacetophenone, furfural, diethylmalonate, 1-(azepan-1-yl)butan-1-one, p-methoxyvalerophenone, n,n-diethylbenzamide, 4,4-dimethylnaphthalen-1(4h)-one, gamma-decalactone, piperitone, ethylacetoacetate, 1-hexylimidazole, dihydromintlactone, 4-heptanone, dimethyl glutarate, 4-(benzyloxy)-4-methylpentan-2-one, 3,3-dimethyl-1-phenoxybutan-2-one, molinate, 7-methoxy-2,2-dimethylchromene, propiophenone, ethyl 2-benzoyl-3-methylbutanoate, n,n-diethyl-2-methylcyclohexane-1-carboxamide, 5-methyl-5-propyl-1,3-dioxan-2-one, 3-methyl-5-(2-oxopropyl)oxolan-2-one, 1-(azepan-1-yl)pentan-1-one, 2-(2-ethoxyethoxy)-ethanolacetate, 2-methyl-1-(1-phenylethyl)imidazole, methyl 6-(diethylamino)-6-oxohexanoate, 5-undecanolide, 4-methyl-5-pentyloxolan-2-one, 2-ethoxyethylbenzoate, 3,4-dihydro-2(1h)-naphthalenone, 1-methoxy-3-(4-methylphenoxy)benzene, n,n-dihexylacetamide, dihydroactinidiolide, 1-pentanoylpiperidine, propan-2-yl 6-(dimethylamino)-6-oxohexanoate, 5,5-dimethyl-4-(3-oxobutyl)oxolan-2-one, 1-octylpyrrolidin-2-one, gamma-undecalactone, 4-ethoxyphenethylacetate, 2-hexanoylcyclohexan-1-one, gamma-methyldecalactone, 1-(azepan-1-yl)-3-methylbutan-1-one, methyl dihydrojasmonate, p-methoxypivalophenone, 2-acetyl-4-tert-butylcyclohexan-1-one, 4,4-dibutyl-gamma-butyrolactone, 4-ethyl-2,6-dimethoxyphenol, n,n-diethylcyclohexanecarboxamide, 5-dodecanolide, 1-hexanoylpiperidine, 1-heptyl-1h-imidazole, 2-isopropoxyethylbenzoate, butanoic anhydride, methylacetoacetate, 2,3,3-trimethylindanone, 5-hexyl-4-methyldihydrofuran-2(3h)-one, phenoxyacetone, 1-propoxy-2-propanol, ethyl di-n-propylthiolcarbamate, 1,2-dimethoxy-4-methylbenzene, tetrahydrofurfurylpropionate, 2-pyrrolidon, 2-methoxypropyl acetate, 4-dodecanolide, 2-ethoxy-4-(methoxymethyl)phenol, n-isopentylpropionanilide, pentylpiperidine-1-carboxylate, 1-(2-ethylpiperidin-1-yl)butan-1-one, isopropyl 2-isopropoxy-benzoate, n,n-dibutylpentanamide, 2,3-dihydro-2,2-dimethyl-7-hydroxybenzofuran, 2-heptanone, 2-[2-(2-methoxypropoxy)propoxy]-1-propanol, 1,2,3,4,5,6,7,8-octahydro-2,8,8-trimethylnaphthalene-2-carbaldehyde, cycloate, 4-methylquinoline, 5-nonanone, n,n-dipentylbutanamide, 3-dimethylamino-2-methylpropiophenone, 2-ethyl-1-pentanoylpiperidine, 4-(ethoxymethyl)-2-methoxyphenol, n,n-dibutylhexanamide, 2-ethylhexyllactate, tripropyleneglycolmonomethylether, magnolione, 1-octylimidazole, butylformate, butylate, 5-ethyl-2-(2-furyl)-4-propyl-m-dioxane, 1-methoxy-4-(2-methoxyethoxymethyl)benzene, hexylpiperidine-1-carboxylate, 4-propylcyclohexanone, 2,5,8,11,14,17-hexaoxaoctadecane, ethyl n,n-diethylsuccinamate, ethyl dipentylcarbamate, 2-butoxyethyl 4-methylbenzoate, 4′-pentylacetophenone, vernolate, 2-cyclopentyl cyclopentanone, 2-butoxyethylbenzoate, trimethoxymethane, phenoyethylpropionate, 4′-isobutylacetophenone, 2-methylindole, n,n,2-triethylhexanamide, 2-methoxy-4-propylphenol, 3,5-bis(2-methylpropyl)cyclohexane-1,2-dione, 2,4-diethoxy-6-methylpyrimidine, ethyl-2-hydroxybenzoate, p-ethoxybenzaldehyde, glycerol triacetate, p-hexylacetophenone, n,n-diisopropyl-phenylacetamide, 3-ethylundecane-4,6-dione, 1-benzazine, methyl 5-methylsalicylate, n,n-dipropylheptanamide, 4-methylpyridine, 4-pentylcyclohexanone, 4-pyridinecarboxaldehyde, oxolan-2-yl methylheptanoate, 2-(2-(4-methylcyclohex-3-enyl)propyl)cyclopentanone, 2-isopropoxyphenol, octanophenon, 2-benzyl-4-methyl-1,3-dioxane, ethylbenzoate, 4-methyl-2-(2-methylpropyl)oxan-4-ol, 3-(diethylamino)propiophenone, benzylacetoacetate, isoamylbenzoate, pyridine, dichloromethane, or 1,1,2,2-tetrachloroethane, but is not limited thereto.

In an exemplary embodiment of the present specification, the non-solvent is any one of an alcohol-based solvent, a ketone-based solvent, an ester-based solvent, an ether-based solvent, a polar nonprotic solvent, a hydrocarbon solvent, or a halogen-containing solvent.

In an exemplary embodiment of the present specification, the non-solvent has a PVC swelling score value of more than 0 according to Equation 1, and is selected in consideration of the difference in solubility for between the good solvent and polyvinyl chloride used together. The non-solvent may be any one selected among propanol, diethylether, n-heptane, hexane, 1,4-butadiol, octane, cyclopentane, propyleneglycol, dimethylsulfoxide, methanol, ethanol, 2-propanol, 2,4-dimethylhexane, 3-ethyl-2,4-dimethylpentane, 2,7-dimethyloctane, 2,6-dimethyl-heptane, 2-methyl-3-ethylpentane, 3,3-dimethylhexane, 2,3,5-trimethylhexane, 2,3,4-trimethylpentane, 2,2-dimethylheptane, 3,3-dimethylpentane, 1-(perfluorobutyl)icosane, 1,1,1,2,2,3,3,4,4-nonafluorotetracosane, 2,5-dimethylhexane, 2,2-dimethylhexane, 2,3,3-trimethylpentane, formicacid, 2,2,6-trimethylheptane, 2,2,4-trimethylhexane, 2,2,3-trimethylpentane, 2,3,3,4-tetramethylpentane, 2,4,4-trimethylhexane, 1-hydroxybenzotriazole, 3-ethyl-2,2-dimethyl-pentane, 2,2,4,6,6-pentamethylheptane, 2,2,5-trimethylhexane, 2-nitroethanol, 2,2,3,4-tetramethylpentane, octamethyltrisiloxane, 2,2,3,3-tetramethylhexane, 1,5-pentanediol, 1,1,1,2,2,3,3-heptafluoroundecane, 2,2,5,5-tetramethylhexane, 2,2,3,3-tetramethylpentane, 2,2,4-trimethylpentane, 2,2,4,4-tetramethylpentane, dodecamethylcyclohexasiloxane, acetaldehydeammonia, 1,1,1,2,2,3,3,4,4-nonafluorohexadecane, dodecamethylpentasiloxane, 1,1,1,2,2,3,3-heptafluorononane, 1,3-dioxolan-2-one, decamethyltetrasiloxane, 1-(perfluorohexyl)docosane, hexamethyldisilane, 1,1,1,2,2,3,3,4,4,5,5-undecafluorononadecane, tetradecamethylhexasiloxane, 1,1,1,2,2,3,3,4,4,5,5,6,6-tridecafluorohexacosane, 1,1,1,2,2,3,3,4,4-nonafluoroundecane, 1,1,1,2,2,3,3,4,4-nonafluorododecane, hexadecamethylheptasiloxane, 1,1,1,2,2,3,3,4,4,5,5,6,6-tridecafluorotetracosane, propynol, 1,1,1,2,2,3,3,4,4-nonafluorodecane, ethanolamine, 1,1,1,2,2,3,3,4,4,5,5,6,6-tridecafluorodocosane, 2-hydroxypropanenitrile, 1,1,1,2,2,3,3,4,4,5,5,6,6-tridecafluoroicosane, 1,1,1,2,2,3,3,4,4-nonafluorononane, 1,1,1,2,2,3,3,4,4,5,5,6,6-tridecafluorooctadecane, cis-2-butene-1,4-diol, 1,1,1,2,2,3,3,4,4,5-decafluorononane, 1,1,1,2,2,3,3,4,4,5,5,6,6,7,7,8,8-heptadecafluorooctacosane, 1,1,1,2,2,3,3,4,4,5,5,6,6-tridecafluorohexadecane, 1,1,1,2,2,3,3,4,4,5,5,6,6,7,7,8,8-heptadecafluorohexacosane, 1,1,1,2,2,3,3,4,4,5,5,6,6,7,7,8,8-heptadecafluoropentacosane, 1,1,1,2,2,3,3,4,4,5,5,6,6-tridecafluoropentadecane, 1,1,1,2,2,3,3,4,4,5,5,6,6,7,7,8,8-heptadecafluorotetracosane, 1-(perfluorohexyl)octane, 1,1,1,2,2,3,3,4,4,5,5-undecafluorodecane, 1,1,1,2,2,3,3,4,4,5,5,6,6-tridecafluorotridecane, 1,1,1,2,2,3,3,4,4,5,5,6,6,7,7,8,8-heptadecafluorodocosane, 1h,8h-hexadecafluorooctane, 1,1,1,2,2,3,3,4,4,5,5,6,6,7,7,8,8,9,9,10,10-henicosafluorotriacontane, hexacosamethyldodecasiloxane, 1,1,1,2,2,3,3,4,4,5,5,6,6,7,7,8,8-heptadecafluoroicosane, 1,1,1,2,2,3,3,4,4,5,5,6,6-tridecafluorododecane, 1,3-propanediol, 1,1,1,2,2,3,3,4,4,5,5,6,6-tridecafluoroundecane, 1,1,1,2,2,3,3,4,4,5,5,6,6,7,7,8,8-heptadecafluorononadecane, 1,1,1,2,2,3,3,4,4,5,5,6,6,7,7,8,8,9,9,10,10-henicosafluorononacosane, 1,1,1,2,2,3,3,4,4,5,5,6,6,7,7,8,8-heptadecafluorooctadecane, 1,1,1,2,2,3,3,4,4,5,5,6,6,7,7-pentadecafluorotetradecane, 1,1,1,2,2,3,3,4,4,5,5,6-dodecafluorononane, 1,1,1,2,2,3,3,4,4,5,5-undecafluorooctane, 1,1,1,2,2,3,3,4,4,5,5,6,6,7,7-pentadecafluorotridecane, 1-perfluorooctyloctane, 1,1,1,2,2,3,3,4,4,5,5,6,6-tridecafluorodecane, 1,1,1,2,2,3,3,4,4,13,13,14,14,15,15,16,16,16-octadecafluorohexadecane, 1,1,1,2,2,3,3,4,4,5,5,6,6,7,7,8,8-heptadecafluoropentadecane, 1,1,1,2,2,3,3,4,4,5,5,6,6,7,7,8,8,9,9,10,10,11,11,12,12-pentacosafluorohentriacontane, formicin, 1,1,1,2,2,3,3,4,4,5,5,6,6,7,7,8,8-heptadecafluorotetradecane, 1-(henicosafluorodecyl)undecane, 1,1,1,2,2,3,3,4,4,5,5,6,6,7,7,8,8-heptadecafluorotridecane, 1,1,1,2,2,3,3,4,4,5,5,6,6,7,7,8,8,9,9,10,10,11,11,12,12-pentacosafluorooctacosane, ethylenecyanohydrin, 1,1,1,2,2,3,3,4,4,5,5,6,6,7,7,8,8,9,9,10,10-henicosafluoroicosane, 1,1,1,2,2,3,3,4,4,5,5,6,6-tridecafluorooctane, perfluorooctylbromide, 1,1,1,2,2,3,3,4,4,5,5,6,6,7,7,8,8,9,9,10,10-henicosafluorooctadecane, 1,1,1,2,2,3,3,4,4,5,5,6,6,7,7,8,8-heptadecafluorododecane, 1,1,1,2,2,3,3,4,4,5,5,6,6,7,7,8,8,9,9,10,10,11,11,12,12-pentacosafluorotetracosane, pentacosafluorotricosane, 1-(perfluorohexyl)propane, 1,1,1,2,2,3,3,4,4,5,5,6,6,7,7,8,8,9,9,10,10-henicosafluoropentadecane, 1,1,1,2,2,3,3,4,4,5,5,6,6,7,7,8,8-heptadecafluorodecane, 1,1,1,2,2,3,3,4,4,5,5,6,6,7,7,8,8,9,9,10,10-henicosafluorotetradecane, 1,1,1,2,2,3,3,4,4,5,5,6,6,7,7,8,8,9,9,10,10,11,11,12,12-pentacosafluorooctadecane, 1,1,1,2,2,3,3,4,4,5,5,6,6,7,7,8,8,9,9,10,10-henicosafluorotridecane, 1,1,1,2,2,3,3,4,4,5,5,6,6,7,7,8,8,9,9,10,10-henicosafluorododecane, glycol, tetratriacontafluorotetracosane, glycerol, 1,1,1,2,2,3,3,4,4,5,5,6,6,7,7,8,8,9,9,10,10,11,11,12,12-pentacosafluorotetradecane, methylhydroperoxide, H₂O, 4-hydroxymethyl-1,3-dioxolan-2-one, hydroxyacetonitrile, perfluorooctane, cis-perfluorodecalin, methanesulfonicacid, formamide, 4-methylphenol, PBr3, H₂O₂, BBr3, methylbutane, 2,2-dimethylbutane, 2,2,3-trimethyl-butane, 2,2-dimethylpentane, 2,3-dimethylbutane, pentane, 2,4-dimethylpentane, 2-methylpentane, 2-methylhexane, 3-methylpentane, 3-methyl-hexane, 3-ethylpentane, 3-ethyl-3-methylpentane, 2-methylheptane, 3,3-diethylpentane, 3-methylheptane, 2-methyloctane, 4-methylheptane, 3-ethylheptane, 2-methyl-nonane, 3-methyloctane, 4-methyloctane, 2-methyldecane, 3-methyl-nonane, 1,1,3,3-tetramethylcyclopentane, 1,3-butanediol, 4-methyldecane, 5-methyl-nonane, 4-methyl-nonane, 1,1-dimethylcyclopentane, 1,1,2-trimethylcyclopentane, 1,1,2-trimethylcyclohexane, n-decane, n-nonane, isobutylcyclopentane, (1-methylethyl)-cyclopentane, tert-butylcyclohexane, pentadecane, tridecane, 1,1,3-trimethylcyclopentane, 1,1,3-trimethylcyclohexane, nonadecane, heptadecane, octadecane, ethylcyclopentane, dodecane, n-undecane, propylcyclopentane, isobutylcyclohexane, isopropylcyclohexane, 1-ethyl-1-methylcyclopentane, 2,3,3-trimethyl-1-butene, 2,4,4-trimethyl-1-pentene, n-hexylcyclopentane, pentylcyclopentane, 1-isopropyl-4-methylcyclohexane, trimethylaluminum, n-tetradecylcyclopentane, tridecylcyclopentane, tetradecane, n-dodecylcyclopentane, n-decylcyclopentane, n-propylcyclohexane, ethylcyclohexane, 3,3-dimethyl-1-butene, n-hexadecane, pentene, 2,3,3-trimethyl-1-pentene, decylcyclohexane, pentylcyclohexane, 3,4-dicyclohexyl-2,5-dimethylhexane, 2-methyl-1-butene, 3,3-dimethyl-1-pentene, 4,4-dimethyl-1-pentene, butylcyclohexane, methylcyclopentane, methylcyclohexane, decahydronaphthalene, hexahydroindene, bicyclohexyl, cyclohexane, 2,4,4-trimethyl-2-pentene, 2,3-dimethyl-1-pentene, tricyclohexylmethane, butylcyclopentane, 1-hexene, 2,3-dimethyl-1-butene, methylformamide, 3,3-dimethyl-1-butyne, triethyleneglycol, 3-methoxy-1,2-propanediol, 2,4-dimethyl-1-pentene, 1-heptene, 3-methyl-1-pentene, 3-ethyl-2-methyl-1-pentene, 1,4-bis(1,1-dimethylethyl)-benzene, diethyleneglycol, octene, methoxyaceticacid, 1-nonene, 4-methyl-1-hexene, 1,2,3,4-tetrahydro-1,1,3,4,4,6-hexamethylnaphthalene, 1,3,5-triisopropylbenzene, 1,2,2,6,6-pentamethylpiperidine, 1,4-diethylbenzene, 2-methyl-2-butene, isoprene, 4-methyl-1-pentene, 1-tetradecene, 3-ethyl-1-pentene, 2-methyl-3-heptene, 1-decene, 2,3,4-trimethyl-2-pentene, 1-nonadecene, butylbenzene, 2-ethoxy-2-methyl-propane, 1,2-diethylbenzene, ethanedial, cyclohexylbenzene, galaxolide, 1,2,3,4-tetramethylbenzene, 1,2,3,5-tetramethylbenzene, pentaethylbenzene, 1,3,5-trimethylbenzene, isobutanol, peroxyaceticacid, 1,6-hexanediol, 2,6-di-tert-butyl-4-methylpyridine, 2,2′-(methylimino)bis-ethanol, 1,3-bis(1-methylethyl)-benzene, 2,7-diisopropylnaphthalene, 1,2,3,5-tetraethylbenzene, tetrahydro-2,2,5,5-tetramethylfuran, 1,5-diisopropylnaphthalene, 2,3-butanediol, 1,2-diisopropylbenzene, benzene, 1-pentan-2-yl-4-pentan-3-ylbenzene, tetradecylbenzene, pentadecylbenzene, ethylbenzene, 3,6-bis-(methoxymethyl)-durene, himachalen_gamma, 1-(1,1-dimethylethyl)-3-methylbenzene, tridecylbenzene, 1-(methoxymethyl)-4-(2,4,4-trimethylpentan-2-yl)benzene, dodecylbenzene, 1,2,4-trimethylbenzene, 1-cyclohexyl-2-isopropylbenzene, dl-pin-2(3)-ene, 2,6-di-tert-butylpyridine, 1,1′-oxybis-octane, 1,5-hexanediol, 1-(1,1-dimethylethyl)-3,5-dimethylbenzene, menthylisovalerate, 1-methyl-7-(1-methylpropyl)naphthalene, tert-butanol, himachalen_beta, dimethoxymethane, 1,2,3,4,5,6,7,8-octahydroanthracene, (1,1-dimethylethyl)benzene, 1,2-hexanediol, cyclohexene, perhydrofarnesylacetone, delta-cadinene, isopropylbenzene, undecylbenzene, 2,5-hexanediol, dipropyleneglycol, 1,6-dimethyl-4-isopropyltetralin, di-n-propylether, diisopropylether, cuparen, 1,4-bis(1-methylethyl)-benzene, 2,4-dimethyl-3-thiapentane, 1-methoxy-4-(2,4,4-trimethylpentan-2-yl)benzene, 1-ethoxybutane, decylbenzene, or cycloheptane, but is not limited thereto.

Yet another exemplary embodiment of the present specification provides recycled polyvinyl chloride obtained by filtering the above-described composition.

In another exemplary embodiment of the present specification, for polyvinyl chloride extracted by the good solvent from waste including polyvinyl chloride in the waste polyvinyl chloride recycled composition, most of polyvinyl chloride may be precipitated by the non-solvent and settled in a solid state. Recycled polyvinyl chloride may be obtained by filtering the composition including polyvinyl chloride in the precipitated state.

In still another exemplary embodiment of the present specification, recycled polyvinyl chloride includes all the states in which the composition has been filtered and in which excess solvents have been removed by drying the composition after filtration.

In an exemplary embodiment of the present specification, the recycled polyvinyl chloride includes an additive derived from waste. In this case, the additive derived from waste is not particularly limited as long as the additive is added for preparing the waste, and examples thereof include a plasticizer, and the like. Since an additive such as a plasticizer is already included when products are produced using the recycled polyvinyl chloride, there is an advantage in that the additive such as a plasticizer is not added or the addition amount can be reduced.

In an exemplary embodiment of the present specification, the waste is not particularly limited as long as the waste includes PVC, and may be, for example, a building material (a pipe, a window frame, and the like), an electric wire coating, synthetic leather, a rubber tub, a hose, a flooring material, a packing material, a medical sap bag, a toy, and the like which include PVC.

In an exemplary embodiment of the present specification, the recycled polyvinyl chloride is PVC extracted by the solvent extraction, and low-molecular weight PVCs are filtered out during solvent extraction, resulting in a higher average molecular weight than PVC prepared by polymerization or PVC in waste. Furthermore, as the average molecular weight of PVC is changed, dynamic physical properties affected by the average molecular weight such as the glass transition temperature (Tg) and melting temperature (Tm) thereof are changed, so dynamic physical properties such as transition temperature (Tg) and melting temperature (Tm) are also increased as the average molecular weight of PVC is increased.

### EXAMPLES

Hereinafter, the present specification will be described in more detail through Examples. However, the following Examples are provided only for exemplifying the present specification, but are not intended to limit the present specification.

### Examples

### Experimental Example 1

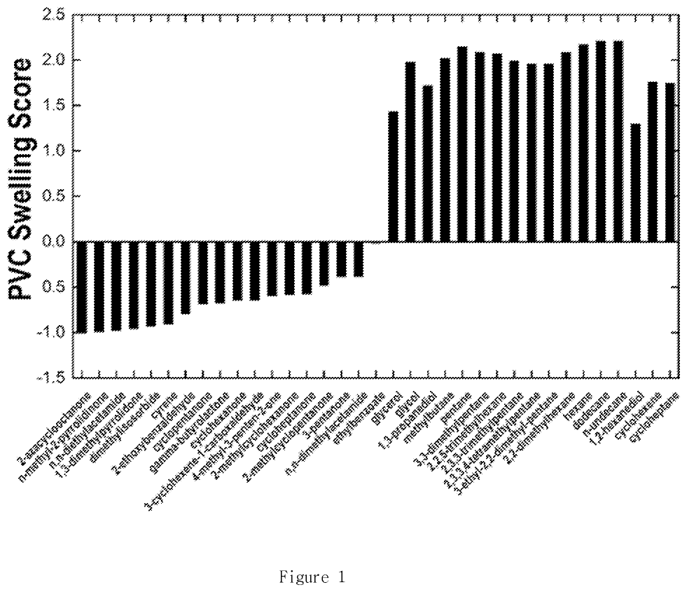

The PVC swelling score values for the solvents in the following Table 1 were derived and are shown in Table 1, and the PVC swelling score values for some of them are shown in FIG. 1. In this case, x₁, x₂, x₃, and x₄ were determined to be 1.5, 1.5, 0.5, and 0.25, respectively, in consideration of 25° C. and 1 atm. [Table 1]

TABLE 1

| | | Fractional | | | | | PVC |
|---|---|---|---|---|---|---|---|
| | | Polar | | | | | swelling |
| Name | Dipole | Surface Area | Log P | PVC_HSP | dH | Asphericity | score |
| 1,2,3,5- | 3.763 | 0.158 | 1.383 | 3.0 | 7.300 | 0.157 | −1.030 |
| tetramethoxybenzene | | | | | | | |
| 3,4,5- | 3.813 | 0.126 | 2.117 | 4.3 | 6.200 | 0.156 | −1.028 |
| trimethoxytoluene | | | | | | | |
| 2-pyrrolidinone,1-ethyl | 4.154 | 0.148 | 0.133 | 2.8 | 7.000 | 0.150 | −1.021 |
| 2-azacyclooctanone | 4.186 | 0.200 | 0.240 | 0.9 | 6.900 | 0.103 | −1.005 |
| 1-acetylpiperidine | 4.024 | 0.131 | 0.730 | 1.3 | 6.500 | 0.207 | −1.003 |
| n-methyl-2- | 4.161 | 0.168 | −0.398 | 3.0 | 7.200 | 0.152 | −0.991 |
| pyrrolidinone | | | | | | | |
| caprolactone | 3.904 | 0.209 | 0.364 | 5.5 | 7.400 | 0.098 | −0.975 |
| n,n-diethylacetamide | 4.090 | 0.124 | 0.316 | 4.9 | 7.500 | 0.107 | −0.974 |
| ethyl1,3-dimethyl-2- | 3.330 | 0.210 | 0.501 | 3.2 | 6.900 | 0.227 | −0.963 |
| oxopyrrolidine-3- | | | | | | | |
| carboxylate | | | | | | | |
| 3-methyl-piperidin-2- | 4.064 | 0.224 | −0.396 | 2.9 | 6.700 | 0.145 | −0.960 |
| one | | | | | | | |
| 1-(2,6- | 3.265 | 0.131 | 1.723 | 3.2 | 6.200 | 0.264 | −0.953 |
| dimethylmorpholin-4- | | | | | | | |
| yl)butan-1-one | | | | | | | |
| 1,3- | 4.170 | 0.145 | | 2.8 | 6.000 | 0.168 | −0.952 |
| dimethylpyrrolidone | | | | | | | |
| 2-ethylhexylsalicylate | 3.157 | 0.162 | 5.770 | 5.1 | 6.100 | 0.213 | −0.950 |
| 1,5- | 4.218 | 0.146 | | 2.8 | 6.000 | 0.159 | −0.950 |
| dimethylpyrrolidone | | | | | | | |
| ethyl3-ethyl-2- | 3.403 | 0.252 | 0.666 | 3.7 | 6.700 | 0.149 | −0.945 |
| oxooxolane-3- | | | | | | | |
| carboxylate | | | | | | | |
| 1-ethyl-3,5,7- | 3.570 | 0.090 | 2.921 | 6.3 | 5.500 | 0.048 | −0.931 |
| trimethyl-1,3-dihydro- | | | | | | | |
| 2h-azepin-2-one | | | | | | | |
| dimethylisosorbide | 3.279 | 0.202 | 0.320 | 5.0 | 5.800 | 0.138 | −0.927 |
| Caprolactam | 4.151 | 0.227 | −0.324 | 1.4 | 7.100 | 0.141 | −0.924 |
| cyclotenebutyrate | 3.894 | 0.212 | 1.831 | 3.2 | 6.700 | 0.290 | −0.913 |
| Ethyl-2-(2- | 3.389 | 0.190 | 1.762 | 3.9 | 7.000 | 0.354 | −0.912 |
| methoxyphenoxy)acetate | | | | | | | |
| 1,4- | 4.204 | 0.145 | | 2.7 | 5.900 | 0.203 | −0.907 |
| dimethylpyrrolidone | | | | | | | |
| Cyrene | 3.656 | 0.298 | −0.510 | 1.5 | 6.900 | 0.089 | −0.905 |
| n,n-dimethylbenzamide | 4.213 | 0.111 | 0.435 | 0.9 | 7.100 | 0.264 | −0.905 |
| n,n- | 3.949 | 0.137 | −0.215 | 3.3 | 7.600 | 0.234 | −0.902 |
| dimethylpropanamide | | | | | | | |
| 2,4,4-trimethyl-6- | 3.402 | 0.183 | 2.304 | 4.4 | 5.700 | 0.219 | −0.900 |
| oxocyclohex-1-en-1- | | | | | | | |
| ylacetate | | | | | | | |
| 1,3- | 4.794 | 0.143 | 0.363 | 1.8 | 7.200 | 0.153 | −0.890 |
| dimethyltetrahydro- | | | | | | | |
| pyrimidin-2(1h)-one | | | | | | | |
| n,n-dimethylbutanamide | 3.958 | 0.123 | 0.316 | 4.7 | 7.400 | 0.301 | −0.889 |
| 3,4-dihydro-2h-1- | 3.843 | 0.182 | 1.803 | 2.1 | 5.800 | 0.252 | −0.888 |
| benzopyran-2-one | | | | | | | |
| tripropyleneglycolethyl- | 3.603 | 0.172 | 0.060 | 6.8 | 7.700 | 0.257 | −0.886 |
| etherisomer | | | | | | | |
| 3,4- | 3.611 | 0.157 | 2.353 | 2.4 | 5.600 | 0.262 | −0.877 |
| dimethoxypropiophenone | | | | | | | |
| 1- | 3.927 | 0.150 | 0.244 | 0.9 | 7.800 | 0.209 | −0.874 |
| piperidinecarboxaldehyde | | | | | | | |
| methylaminoacetaldehyde- | 2.990 | 0.185 | 0.207 | 6.6 | 7.200 | 0.236 | −0.874 |
| dimethylacetal | | | | | | | |
| methyl2,6- | 4.770 | 0.201 | 1.767 | 2.1 | 6.300 | 0.133 | −0.866 |
| dimethoxybenzoate | | | | | | | |
| 2-cyclohexen-1-one | 3.618 | 0.158 | 0.450 | 3.0 | 5.300 | 0.176 | −0.864 |
| n,n,2- | 4.110 | 0.099 | 0.895 | 1.1 | 7.600 | 0.200 | −0.860 |
| trimethylbenzamide | | | | | | | |
| 1,3-dimethyl-2,3- | 4.016 | 0.105 | 1.977 | 3.9 | 5.600 | 0.181 | −0.857 |
| dihydroquinolin-4(1h)- | | | | | | | |
| one | | | | | | | |
| n,n,3- | 4.340 | 0.099 | 0.895 | 1.3 | 7.300 | 0.240 | −0.855 |
| trimethylbenzamide | | | | | | | |
| ethyl3,5- | 3.959 | 0.187 | 2.381 | 3.0 | 5.800 | 0.277 | −0.851 |
| dimethoxybenzoate | | | | | | | |
| 4-methoxybenzaldehyde | 4.365 | 0.172 | 1.700 | 1.2 | 6.800 | 0.367 | −0.845 |
| ethyl(4- | 3.247 | 0.160 | 2.400 | 4.6 | 6.200 | 0.429 | −0.843 |
| methylphenoxy)acetate | | | | | | | |
| 2′3′4′- | 5.003 | 0.183 | 1.824 | 1.9 | 6.500 | 0.181 | −0.841 |
| trimethoxyacetophenone | | | | | | | |
| 4-acetylmorpholine | 3.272 | 0.192 | −0.324 | 0.8 | 7.800 | 0.216 | −0.840 |
| ethylimidazole | 4.089 | 0.144 | 0.320 | 3.2 | 5.700 | 0.278 | −0.839 |
| ethyl3- | 4.344 | 0.196 | 0.585 | 3.3 | 6.900 | 0.334 | −0.839 |
| acetyl(ethyl)aminopropanoate | | | | | | | |
| methyl2- | 3.637 | 0.211 | 1.419 | 3.8 | 5.600 | 0.228 | −0.834 |
| oxocyclooctanecarboxylate | | | | | | | |
| ethyl2-methyl-4- | 4.162 | 0.212 | 1.173 | 3.4 | 6.300 | 0.316 | −0.834 |
| oxocyclohex-2- | | | | | | | |
| enecarboxylate | | | | | | | |
| 2′5′- | 4.772 | 0.170 | 2.106 | 1.9 | 6.000 | 0.209 | −0.816 |
| dimethoxyacetophenone | | | | | | | |
| isobutylformate | 4.412 | 0.197 | 1.177 | 7.2 | 6.700 | 0.356 | −0.815 |
| Ethyl-2-(2,6- | 3.188 | 0.146 | 2.861 | 5.5 | 5.700 | 0.336 | −0.811 |
| dimethylphenoxy)acetate | | | | | | | |
| Ethyl-2- | 3.257 | 0.161 | 2.721 | 5.5 | 5.900 | 0.418 | −0.805 |
| (benzyloxy)acetate | | | | | | | |
| hexylacetoacetate | 3.361 | 0.163 | 2.841 | 6.1 | 5.700 | 0.384 | −0.805 |
| diethylglutarate | 3.585 | 0.234 | 1.530 | 6.5 | 6.800 | 0.424 | −0.805 |
| 4-carbethoxy-2-ethyl- | 4.386 | 0.178 | 2.294 | 4.5 | 5.800 | 0.263 | −0.804 |
| 3-methyl-2-cyclohexen- | | | | | | | |
| 1-one | | | | | | | |
| nepetalactone | 3.880 | 0.152 | 2.829 | 5.1 | 4.900 | 0.097 | −0.799 |
| tripropyleneglycolbutylether | 2.983 | 0.153 | 1.026 | 7.1 | 7.600 | 0.274 | −0.797 |
| ethyl5,5-dimethyl-2- | 4.098 | 0.254 | 0.920 | 4.5 | 6.800 | 0.306 | −0.795 |
| oxofuran-3-carboxylate | | | | | | | |
| 2-ethoxybenzaldehyde | 4.647 | 0.155 | 2.247 | 2.4 | 5.700 | 0.202 | −0.793 |
| n,n-diethyl-3-(2- | 4.737 | 0.148 | 0.465 | 3.1 | 6.000 | 0.273 | −0.789 |
| methyl-1,3-dioxolan-2- | | | | | | | |
| yl)propanamide | | | | | | | |
| isophorone | 3.785 | 0.095 | 2.073 | 4.7 | 5.000 | 0.095 | −0.784 |
| methyl-2,4- | 4.754 | 0.201 | 1.996 | 2.1 | 6.300 | 0.268 | −0.784 |
| dimethoxybenzoate | | | | | | | |
| 5,5-diethyl-4- | 5.253 | 0.179 | 0.907 | 5.0 | 5.600 | 0.010 | −0.775 |
| methoxyfuran-2(5H)-one | | | | | | | |
| ethyl4,6-dimethyl-2- | 3.081 | 0.240 | 2.220 | 3.8 | 7.400 | 0.254 | −0.772 |
| oxo-3,4-dihydro-2h- | | | | | | | |
| pyran-5-carboxylate | | | | | | | |
| ethyl4- | 3.218 | 0.151 | 2.928 | 5.7 | 5.800 | 0.451 | −0.758 |
| phenoxybutanoate | | | | | | | |
| 2,5- | 4.747 | 0.157 | 2.637 | 2.4 | 5.600 | 0.200 | −0.757 |
| dimethoxypropiophenone | | | | | | | |
| ethyl5,5-dimethyl-2- | 3.695 | 0.249 | 0.627 | 5.1 | 5.800 | 0.297 | −0.757 |
| oxotetrahydrofuran-3- | | | | | | | |
| carboxylate | | | | | | | |
| ethyl3-(5- | 3.526 | 0.263 | −0.021 | 4.0 | 7.000 | 0.402 | −0.756 |
| oxotetrahydrofuran-2- | | | | | | | |
| yl)propanoate | | | | | | | |
| benzylsalicylate | 3.266 | 0.200 | 4.007 | 2.2 | 7.800 | 0.327 | −0.755 |
| 1-heptanoyl-4- | 3.860 | 0.087 | 2.275 | 3.3 | 5.900 | 0.416 | −0.753 |
| methylpiperazine | | | | | | | |
| n-n-propylpyrrolidone | 4.176 | 0.131 | | 3.9 | 5.300 | 0.249 | −0.751 |
| n,n-diethyl-4-methyl- | 4.108 | 0.098 | 1.597 | 4.1 | 5.300 | 0.207 | −0.749 |
| 4h-pyridine-1- | | | | | | | |
| carboxamide | | | | | | | |
| p-tolylacetonitrile | 3.691 | 0.148 | 1.909 | 2.7 | 5.200 | 0.316 | −0.749 |
| 5-methyl-2(3h)- | 3.966 | 0.248 | 0.837 | 3.2 | 7.600 | 0.265 | −0.748 |
| furanone | | | | | | | |
| 1-methyl-2-(3- | 3.743 | 0.099 | 1.802 | 4.4 | 5.300 | 0.284 | −0.747 |
| pyridyl)pyrrole | | | | | | | |
| formicacidpentylester | 4.413 | 0.176 | 1.893 | 7.1 | 6.300 | 0.461 | −0.745 |
| n-isopropylpyrrolidone | 4.214 | 0.130 | | 4.4 | 5.000 | 0.138 | −0.743 |
| ethy-14- | 3.383 | 0.127 | 3.144 | 4.7 | 5.400 | 0.381 | −0.740 |
| (dimethylamino)benzoate | | | | | | | |
| n-butylacetamide | 3.629 | 0.188 | 1.504 | 3.3 | 7.800 | 0.412 | −0.738 |
| 1-morpholinopentan-1- | 3.230 | 0.143 | 1.270 | 2.7 | 5.400 | 0.361 | −0.738 |
| one | | | | | | | |
| 4-methylbenzaldehyde | 3.169 | 0.123 | 2.100 | 3.1 | 5.400 | 0.335 | −0.729 |
| 3′,4′- | 3.615 | 0.144 | 2.700 | 3.6 | 4.900 | 0.252 | −0.723 |
| dimethoxyisobutyrophenone | | | | | | | |
| benzaldehyde | 3.051 | 0.145 | 1.640 | 3.6 | 5.300 | 0.281 | −0.716 |
| 1,2,4-triethoxybenzene | 2.906 | 0.111 | 3.395 | 4.8 | 5.500 | 0.213 | −0.714 |
| n-methyl-o- | 2.767 | 0.101 | 1.530 | 1.1 | 7.600 | 0.159 | −0.713 |
| acetotoluidide | | | | | | | |
| Isobutylphenoxyacetate | 3.204 | 0.150 | 2.819 | 6.4 | 5.500 | 0.425 | −0.711 |
| m-dimethoxybenzene | 3.017 | 0.113 | 1.929 | 3.8 | 5.600 | 0.334 | −0.711 |
| 3-oxobutanoicacid-1- | 4.325 | 0.243 | 1.063 | 5.7 | 6.200 | 0.359 | −0.708 |
| methylethylester | | | | | | | |
| Ethyl-2- | 3.490 | 0.167 | 3.654 | 6.8 | 4.700 | 0.199 | −0.703 |
| (cyclohexylmethyl)-3- | | | | | | | |
| oxobutanoate | | | | | | | |
| 5-ethyldihydro-2(3h)- | 4.709 | 0.207 | 0.259 | 4.5 | 5.700 | 0.241 | −0.701 |
| furanone | | | | | | | |
| 2-isopropyl-n,2,3- | 3.602 | 0.121 | 1.936 | 6.3 | 4.400 | 0.080 | −0.698 |
| trimethylbutyramide | | | | | | | |
| 4-(4- | 3.052 | 0.080 | 2.485 | 2.5 | 5.800 | 0.357 | −0.698 |
| methylpiperidino)pyridine | | | | | | | |
| 3-oxaspiro-undecan-2- | 4.314 | 0.143 | 1.877 | 3.9 | 4.900 | 0.156 | −0.697 |
| one | | | | | | | |
| formicacidhexylester | 4.406 | 0.158 | 2.424 | 7.4 | 5.900 | 0.467 | −0.696 |
| methyl2,2-dimethyl- | 3.850 | 0.265 | 0.272 | 2.9 | 5.400 | 0.195 | −0.694 |
| 4,6- | | | | | | | |
| dioxocyclohexanecarboxylate | | | | | | | |
| ethyl6-ethyl-2-methyl- | 4.172 | 0.180 | 2.196 | 5.1 | 5.000 | 0.215 | −0.690 |
| 4-oxocyclohex-2-ene-1- | | | | | | | |
| carboxylate | | | | | | | |
| Benzenepropanenitrile | 3.564 | 0.152 | 1.719 | 3.2 | 5.100 | 0.376 | −0.690 |
| 4,4-dimethyl-5,6,7,8- | 4.167 | 0.130 | 2.269 | 5.7 | 4.800 | 0.162 | −0.688 |
| tetrahydro-1H- | | | | | | | |
| isochromen-3-one | | | | | | | |
| ethyl2,6-dimethyl-4- | 4.382 | 0.194 | 1.665 | 4.5 | 5.400 | 0.284 | −0.686 |
| oxocyclohex-2- | | | | | | | |
| enecarboxylate | | | | | | | |
| rhodiasolv-adma8 | 3.958 | 0.086 | 2.442 | 4.7 | 5.700 | 0.440 | −0.684 |
| 5-methyl-1-propyl-2- | 4.026 | 0.117 | | 5.1 | 4.900 | 0.223 | −0.683 |
| pyrrolidinone | | | | | | | |
| cyclopentanone | 2.927 | 0.180 | 0.198 | 3.7 | 5.200 | 0.186 | −0.681 |
| 1-(2,5- | 4.079 | 0.089 | 2.744 | 4.5 | 5.300 | 0.299 | −0.680 |
| dimethylpyrrolidin-1- | | | | | | | |
| yl)pentan-1-one | | | | | | | |
| Nicotine | 2.691 | 0.086 | 0.720 | 2.3 | 6.500 | 0.247 | −0.678 |
| gamma-butyrolactone | 4.553 | 0.290 | −0.764 | 7.0 | 7.400 | 0.183 | −0.675 |
| t-butylacetoacetate | 4.237 | 0.210 | 1.413 | 6.9 | 5.500 | 0.332 | −0.675 |
| 4- | 3.014 | 0.101 | 1.873 | 4.6 | 5.700 | 0.395 | −0.674 |
| (methoxymethyl)anisole | | | | | | | |
| Mintlactone | 5.412 | 0.149 | 1.829 | 4.1 | 5.700 | 0.210 | −0.670 |
| 2- | 3.423 | 0.272 | −0.074 | 4.1 | 7.900 | 0.248 | −0.668 |
| methoxyethylacetoacetate | | | | | | | |
| p-(2,2- | 5.401 | 0.149 | 1.900 | 3.5 | 6.600 | 0.398 | −0.667 |
| dimethoxyethoxy)anisole | | | | | | | |
| n-3-pentylpyrrolidone | 4.191 | 0.106 | | 5.7 | 4.600 | 0.069 | −0.667 |
| Dimethoxytetrahydrofuran | 3.019 | 0.179 | −0.835 | 4.6 | 8.200 | 0.233 | −0.656 |
| propyleneglycolmonoethyl- | 2.870 | 0.190 | 0.797 | 7.1 | 7.700 | 0.322 | −0.656 |
| etheracetate | | | | | | | |
| n,n-dimethyl-4- | 4.303 | 0.084 | 1.774 | 3.0 | 5.500 | 0.336 | −0.655 |
| (propan-2-yl)benzamide | | | | | | | |
| n-methylformanilide | 2.735 | 0.127 | 1.090 | 0.8 | 7.500 | 0.299 | −0.655 |
| 1,3-dimethyl-4- | 4.770 | 0.088 | 3.260 | 6.3 | 5.300 | 0.152 | −0.655 |
| ethylcarbostyril | | | | | | | |
| 1-(4- | 2.729 | 0.173 | 1.005 | 1.8 | 6.800 | 0.418 | −0.652 |
| methoxyphenoxy)acetone | | | | | | | |
| glycerol-tripropionate | 2.867 | 0.263 | 1.357 | 6.0 | 7.200 | 0.276 | −0.651 |
| n,n-dimethyl-m- | 2.835 | 0.065 | 2.227 | 5.3 | 5.800 | 0.231 | −0.649 |
| anisidine | | | | | | | |
| n,n,4- | 4.306 | 0.099 | 0.895 | 0.9 | 8.000 | 0.320 | −0.645 |
| trimethylbenzamide | | | | | | | |
| 2,4- | 3.236 | 0.106 | 2.560 | 4.1 | 4.800 | 0.241 | −0.645 |
| dimethylbenzaldehyde | | | | | | | |
| paraldehyde | 2.573 | 0.181 | 0.858 | 7.4 | 6.000 | 0.137 | −0.644 |
| glycerol-tributyrate | 2.887 | 0.224 | 2.951 | 7.5 | 5.700 | 0.279 | −0.642 |
| 2,3,4,5- | 2.510 | 0.144 | 1.869 | 3.5 | 6.600 | 0.188 | −0.642 |
| tetramethoxytoluene | | | | | | | |
| cyclohexanone | 2.818 | 0.152 | 0.762 | 3.4 | 5.100 | 0.145 | −0.641 |
| 1,3,3-trimethyl-2h- | 4.022 | 0.091 | 2.518 | 3.4 | 4.700 | 0.154 | −0.641 |
| quinolin-4-one | | | | | | | |
| 3-cyclohexene-1- | 2.619 | 0.137 | 1.588 | 3.6 | 6.100 | 0.251 | −0.641 |
| carboxaldehyde | | | | | | | |
| n-sec-butylpyrrolidone | 4.206 | 0.117 | | 5.4 | 4.500 | 0.093 | −0.640 |
| mesitenelactone | 6.317 | 0.187 | 0.976 | 2.9 | 7.300 | 0.163 | −0.640 |
| isobutylsalicylate | 2.874 | 0.214 | 3.644 | 3.1 | 7.600 | 0.328 | −0.639 |
| Bmpc | 2.682 | 0.159 | 3.036 | 4.5 | 5.400 | 0.119 | −0.635 |
| (2,2- | 3.847 | 0.112 | 2.997 | 6.4 | 4.800 | 0.287 | −0.635 |
| diethoxyethoxy)benzene | | | | | | | |
| methyl3-(5-oxooxolan- | 3.577 | 0.287 | −0.553 | 3.4 | 7.600 | 0.390 | −0.632 |
| 2-yl)propanoate | | | | | | | |
| 4-acetoxy-2,5- | 3.301 | 0.286 | 0.805 | 1.8 | 8.100 | 0.161 | −0.628 |
| dimethyl-3(2h)- | | | | | | | |
| furanone | | | | | | | |
| 3-ethylchroman-2-one | 3.848 | 0.145 | 2.827 | 4.0 | 4.400 | 0.201 | −0.620 |
| ethyl3-cyclohexyl-3- | 4.319 | 0.195 | 2.776 | 5.6 | 5.400 | 0.405 | −0.614 |
| oxopropanoate | | | | | | | |
| 1,3-dimethyl-2- | 5.077 | 0.160 | −0.025 | 1.1 | 8.100 | 0.186 | −0.613 |
| imidazolidinone | | | | | | | |
| 1-propyl-2(1h)- | 6.136 | 0.125 | 0.833 | 3.7 | 6.100 | 0.256 | −0.612 |
| pyridinone | | | | | | | |
| 7-methyl-4,4a,5,6- | 4.681 | 0.097 | 2.126 | 4.7 | 5.300 | 0.278 | −0.606 |
| tetrahydro-2(3h)- | | | | | | | |
| naphthalenone | | | | | | | |
| 1-(3,5- | 4.359 | 0.124 | 1.960 | 4.6 | 5.000 | 0.308 | −0.606 |
| dimethylphenoxy)propan- | | | | | | | |
| 2-one | | | | | | | |
| ethyl3-(2,5,5- | 3.655 | 0.158 | 2.172 | 7.1 | 4.800 | 0.390 | −0.605 |
| trimethyl-1,3-dioxan- | | | | | | | |
| 2-yl)propanoate | | | | | | | |
| 1-butyl-5-methyl-2- | 4.280 | 0.106 | | 5.6 | 4.800 | 0.225 | −0.603 |
| pyrrolidinone | | | | | | | |
| 1-tetralone | 3.256 | 0.113 | 2.612 | 3.9 | 4.400 | 0.190 | −0.596 |
| 4-methyl-3-penten-2- | 2.931 | 0.123 | 1.115 | 5.9 | 5.000 | 0.262 | −0.593 |
| one | | | | | | | |
| 1-(4-methylpiperidin- | 4.004 | 0.097 | 2.285 | 3.9 | 4.900 | 0.326 | −0.592 |
| 1-yl)butan-1-one | | | | | | | |
| n-t-butylpyrrolidone | 4.175 | 0.111 | | 6.0 | 4.400 | 0.135 | −0.589 |
| 1,3-dioxane | 2.457 | 0.182 | −0.443 | 3.3 | 7.200 | 0.118 | −0.589 |
| Methyl-2-(4-(tert- | 3.170 | 0.131 | 3.097 | 6.6 | 5.000 | 0.415 | −0.588 |
| butyl)phenoxy)acetate | | | | | | | |
| (6s)-(+)-8,9- | 3.629 | 0.109 | 2.636 | 5.5 | 4.200 | 0.164 | −0.586 |
| dehydrotheaspirone | | | | | | | |
| ethyl4-ethoxybenzoate | 3.698 | 0.161 | 3.333 | 4.7 | 4.700 | 0.378 | −0.586 |
| maltylisobutyrate | 5.252 | 0.246 | 1.362 | 2.4 | 7.500 | 0.237 | −0.584 |
| 4-methyl-1,3-dioxane | 2.453 | 0.154 | 0.049 | 4.9 | 6.400 | 0.182 | −0.584 |
| 2-acetylpyridine | 2.670 | 0.215 | 0.869 | 1.9 | 6.000 | 0.269 | −0.583 |
| 1,4-diethoxybenzene | 3.113 | 0.094 | 3.162 | 4.9 | 5.200 | 0.400 | −0.583 |
| 1-(2,2- | 3.776 | 0.103 | 3.457 | 6.2 | 4.700 | 0.325 | −0.581 |
| diethoxyethoxy)-4- | | | | | | | |
| methylbenzene | | | | | | | |
| octahydrocoumarin | 4.346 | 0.170 | 1.347 | 4.8 | 4.700 | 0.244 | −0.581 |
| 2-methylcyclohexanone | 2.889 | 0.129 | 1.254 | 4.2 | 4.700 | 0.143 | −0.580 |
| butylcarbitolacetate | 2.499 | 0.176 | 1.154 | 7.3 | 6.100 | 0.174 | −0.580 |
| cycloheptanone | 2.790 | 0.131 | 1.326 | 4.3 | 4.800 | 0.099 | −0.575 |
| n-methylbenzamide | 3.824 | 0.188 | 1.663 | 2.4 | 8.500 | 0.319 | −0.573 |
| 3-acetyl-5- | 4.056 | 0.230 | 0.283 | 4.7 | 5.000 | 0.299 | −0.572 |
| propyldihydrofuran- | | | | | | | |
| 2(3h)-one | | | | | | | |
| 2,2- | 3.517 | 0.104 | 2.801 | 7.1 | 4.400 | 0.256 | −0.568 |
| diethoxyethoxymethylbenzene | | | | | | | |
| n-methyl-m- | 2.585 | 0.204 | 1.626 | 1.7 | 6.900 | 0.331 | −0.559 |
| tolylcarbamate | | | | | | | |
| ethyleneglycoldibutyrate | 2.582 | 0.217 | 2.071 | 7.2 | 6.100 | 0.222 | −0.557 |
| methyllaitone | 4.622 | 0.145 | 1.805 | 4.0 | 4.900 | 0.294 | −0.557 |
| (3s,3as,7as)- | 4.832 | 0.151 | 1.634 | 5.1 | 4.900 | 0.243 | −0.555 |
| winelactone | | | | | | | |
| Ethyl-2-(2- | 2.995 | 0.212 | 1.150 | 4.6 | 5.200 | 0.360 | −0.552 |
| oxocyclohexyl)acetate | | | | | | | |
| 4-(2- | 2.586 | 0.160 | 2.071 | 4.6 | 6.300 | 0.397 | −0.544 |
| acetoxyethoxy)toluene | | | | | | | |
| 4-(2,5-dimethylpyrrol- | 3.268 | 0.071 | 2.036 | 6.2 | 4.400 | 0.170 | −0.541 |
| 1-yl)-2,6- | | | | | | | |
| dimethylmorpholine | | | | | | | |
| 1-butylpyridin-2(1h)- | 6.137 | 0.113 | 1.364 | 4.4 | 5.900 | 0.299 | −0.538 |
| one | | | | | | | |
| n,n-dimethyldecanamid | 3.958 | 0.075 | 3.504 | 5.5 | 5.200 | 0.461 | −0.538 |
| valeraldehyde | 2.687 | 0.145 | 1.438 | 6.3 | 5.800 | 0.413 | −0.535 |
| Anabasine | 2.676 | 0.141 | 0.852 | 4.7 | 5.500 | 0.315 | −0.530 |
| 1-(4-methylpiperidin- | 3.995 | 0.089 | 2.817 | 4.2 | 4.800 | 0.364 | −0.530 |
| 1-yl)pentan-1-one | | | | | | | |
| 3-methylcyclohexanone | 2.826 | 0.129 | 1.254 | 4.1 | 4.700 | 0.168 | −0.530 |
| 4′- | 4.488 | 0.138 | 2.271 | 3.3 | 4.900 | 0.371 | −0.527 |
| methoxypropiophenone | | | | | | | |
| 4-tert-butyl-n,n- | 4.265 | 0.075 | 2.123 | 4.1 | 5.000 | 0.339 | −0.527 |
| dimethylbenzamide | | | | | | | |
| acetylacetone | 5.512 | 0.265 | 0.339 | 5.4 | 6.200 | 0.292 | −0.524 |
| ethyl2-methyl-2- | 2.812 | 0.146 | 2.637 | 6.8 | 4.800 | 0.225 | −0.517 |
| phenoxypropanoate | | | | | | | |
| ethyl2-acetyl-5- | 5.890 | 0.253 | 1.215 | 4.2 | 6.500 | 0.307 | −0.517 |
| oxohexanoate | | | | | | | |
| n-sec- | 4.178 | 0.105 | | 6.3 | 4.200 | 0.173 | −0.512 |
| isopentylpyrrolidone | | | | | | | |
| 4,5-dihydro-2- | 4.178 | 0.324 | −0.510 | 2.6 | 5.100 | 0.165 | −0.511 |
| methylthiazole | | | | | | | |
| 4-methyl-1-tetralone | 3.258 | 0.100 | 3.105 | 4.5 | 4.000 | 0.153 | −0.511 |
| 2-butoxyethanolacetate | 2.524 | 0.175 | 1.512 | 7.2 | 6.800 | 0.391 | −0.510 |
| isobutyricanhydride | 4.905 | 0.222 | 1.274 | 7.2 | 5.300 | 0.309 | −0.510 |
| n-hexyl-2- | 4.156 | 0.098 | 2.259 | 5.7 | 4.800 | 0.382 | −0.509 |
| pyrrolidinone | | | | | | | |
| 3-benzyl-2,4- | 4.792 | 0.157 | 1.889 | 4.5 | 4.700 | 0.250 | −0.508 |
| pentanedione | | | | | | | |
| ethyl5-oxodecanoate | 4.346 | 0.164 | 2.985 | 6.9 | 5.000 | 0.471 | −0.504 |
| dihydrojasmonate | 4.196 | 0.167 | 2.672 | 5.8 | 4.500 | 0.332 | −0.503 |
| Ethyllaitone | 4.583 | 0.133 | 2.336 | 4.7 | 4.600 | 0.274 | −0.501 |
| n,n′- | 5.067 | 0.094 | 3.163 | 6.2 | 5.400 | 0.375 | −0.496 |
| dibutylethyleneurea | | | | | | | |
| n,n-diethylformamide | 3.884 | 0.141 | 0.053 | 5.1 | 9.200 | 0.104 | −0.495 |
| methyl3-oxododecanoate | 4.273 | 0.153 | 4.436 | 7.3 | 4.900 | 0.476 | −0.493 |
| 3-methyl-5-isopropyl- | 4.422 | 0.166 | 2.543 | 6.1 | 4.300 | 0.224 | −0.490 |
| 4-carbethoxy-2- | | | | | | | |
| cyclohexene-1-one | | | | | | | |
| 6-pentyl-2h-pyran-2- | 6.159 | 0.139 | 2.511 | 4.9 | 5.800 | 0.373 | −0.490 |
| one | | | | | | | |
| m-methoxyacetophenone | 4.713 | 0.151 | 1.840 | 3.5 | 4.700 | 0.307 | −0.486 |
| benzisoxazole | 3.463 | 0.220 | 1.520 | 4.3 | 8.800 | 0.242 | −0.483 |
| n,n- | 5.068 | 0.153 | 0.330 | 3.2 | 4.700 | 0.222 | −0.482 |
| diethylnicotinamide | | | | | | | |
| ethyl3-(2- | 2.981 | 0.195 | 1.505 | 5.1 | 4.900 | 0.391 | −0.482 |
| oxocyclohexyl)propanoate | | | | | | | |
| 2-methylcyclopentanone | 2.922 | 0.149 | 0.690 | 4.9 | 4.100 | 0.120 | −0.481 |
| propyl4-ethoxybenzoate | 3.413 | 0.149 | 3.864 | 5.5 | 4.300 | 0.402 | −0.479 |
| 5-butyl-5- | 4.321 | 0.116 | 2.958 | 6.4 | 4.000 | 0.159 | −0.467 |
| ethyltetrahydro-2h- | | | | | | | |
| pyran-2-one | | | | | | | |
| ethyl2-oxo-1- | 2.926 | 0.175 | 2.426 | 5.8 | 4.100 | 0.126 | −0.466 |
| propylcyclohexanecarboxylate | | | | | | | |
| 2-propoxyethylacetate | 2.532 | 0.192 | 0.980 | 7.4 | 6.200 | 0.384 | −0.466 |
| dimethyl2- | 2.963 | 0.251 | 0.967 | 5.1 | 5.000 | 0.292 | −0.462 |
| methylglutarate | | | | | | | |
| o-methylcorypalline | 2.445 | 0.090 | 1.807 | 5.4 | 6.200 | 0.243 | −0.458 |
| 1-pentylimidazole | 3.926 | 0.101 | 1.916 | 5.0 | 4.500 | 0.413 | −0.455 |
| n-formylmorpholine | 3.065 | 0.222 | −1.302 | 4.3 | 8.700 | 0.220 | −0.450 |
| methyl2-butoxybenzoate | 2.972 | 0.148 | 3.635 | 5.0 | 4.200 | 0.245 | −0.449 |
| 7-butyloxepan-2-one | 3.914 | 0.134 | 2.450 | 6.9 | 4.000 | 0.312 | −0.447 |
| propanoicacid, anhydride | 4.878 | 0.276 | 0.580 | 5.8 | 7.700 | 0.385 | −0.446 |
| 4-methylcyclohexanone | 2.820 | 0.129 | 1.254 | 4.5 | 4.500 | 0.224 | −0.444 |
| acetophenone | 3.152 | 0.123 | 1.665 | 3.8 | 4.000 | 0.268 | −0.443 |
| 1-(3-methylpiperidin- | 3.993 | 0.089 | 2.817 | 4.5 | 4.400 | 0.359 | −0.440 |
| 1-yl)pentan-1-one | | | | | | | |
| 1-butyl-2-methyl- | 3.945 | 0.099 | 1.464 | 5.7 | 4.100 | 0.294 | −0.438 |
| imidazole | | | | | | | |
| Anisaldehyddiethylacetal | 2.790 | 0.110 | 3.215 | 5.7 | 4.800 | 0.285 | −0.437 |
| 1-(2-methylpiperidin- | 3.946 | 0.090 | 2.817 | 5.3 | 4.200 | 0.311 | −0.434 |
| 1-yl)pentan-1-one | | | | | | | |
| Decalacton | 4.591 | 0.128 | 2.394 | 6.3 | 4.100 | 0.192 | −0.434 |
| 2,4,6- | 3.095 | 0.094 | 3.020 | 6.0 | 4.000 | 0.198 | −0.431 |
| trimethylbenzaldehyde | | | | | | | |
| n,n-diethylcyclohex-3- | 3.902 | 0.091 | 2.061 | 4.6 | 3.900 | 0.226 | −0.430 |
| ene-1-carboxamide | | | | | | | |
| butan-2-yl4- | 3.389 | 0.148 | 3.680 | 6.0 | 3.900 | 0.342 | −0.429 |
| methoxybenzoate | | | | | | | |
| propylene-glycol- | 3.122 | 0.139 | 2.074 | 5.5 | 8.900 | 0.310 | −0.427 |
| alpha-methylbenzyl- | | | | | | | |
| ether | | | | | | | |
| 5-(benzyloxy)pentan-2- | 4.406 | 0.117 | 2.108 | 5.6 | 4.600 | 0.420 | −0.420 |
| one | | | | | | | |
| n,n- | 3.958 | 0.066 | 4.567 | 5.9 | 4.800 | 0.473 | −0.417 |
| dimethyldodecanamide | | | | | | | |
| n,n-diethyl-m- | 4.159 | 0.085 | 1.958 | 4.1 | 4.100 | 0.244 | −0.415 |
| toluamide | | | | | | | |
| (s)-dihydrobovolide | 5.442 | 0.121 | 2.962 | 6.7 | 5.000 | 0.335 | −0.412 |
| (2s,8as)-3,4-dihydro- | 3.575 | 0.107 | 2.273 | 6.4 | 3.200 | 0.109 | −0.411 |
| 3-oxoedulan | | | | | | | |
| butyl2-methoxybenzoate | 3.040 | 0.148 | 3.635 | 5.0 | 4.200 | 0.350 | −0.409 |
| 2-pentanone | 2.780 | 0.141 | 0.905 | 6.5 | 4.700 | 0.325 | −0.407 |
| 2-methoxy-n,n- | 5.025 | 0.136 | 0.710 | 1.4 | 8.800 | 0.163 | −0.407 |
| dimethylbenzamide | | | | | | | |
| 7-cyclohexyloxepan-2- | 3.916 | 0.127 | 2.916 | 6.6 | 3.700 | 0.269 | −0.406 |
| one | | | | | | | |
| 1,4- | 2.541 | 0.237 | 1.426 | 5.3 | 7.100 | 0.393 | −0.404 |
| cyclohexanedicarboxylic- | | | | | | | |
| aciddimethylester | | | | | | | |
| delta-decalactone | 4.333 | 0.134 | 2.417 | 6.3 | 4.200 | 0.364 | −0.392 |
| ethyl-2-(2,5- | 2.809 | 0.124 | 3.557 | 7.2 | 4.200 | 0.180 | −0.392 |
| dimethylphenoxy)-2- | | | | | | | |
| methylpropanoate | | | | | | | |
| 4,4a,5,6,7,8- | 3.627 | 0.083 | 3.004 | 6.2 | 3.400 | 0.137 | −0.392 |
| hexahydro-4a,8- | | | | | | | |
| dimethylnaphthalen- | | | | | | | |
| 2(3h)-one | | | | | | | |
| massoialactone | 5.219 | 0.137 | 2.540 | 5.6 | 4.800 | 0.363 | −0.389 |
| Ethyl-2-(2-oxooxolan- | 5.608 | 0.287 | −0.207 | 3.4 | 7.500 | 0.354 | −0.387 |
| 3-yl)acetate | | | | | | | |
| methyloctalacton | 4.548 | 0.145 | 1.814 | 6.6 | 4.000 | 0.255 | −0.387 |
| 3-pentanone | 2.738 | 0.141 | 0.905 | 6.9 | 4.700 | 0.316 | −0.385 |
| 2,4-diacetylfuran | 2.842 | 0.222 | 0.623 | 4.0 | 4.200 | 0.104 | −0.384 |
| 2′- | 3.950 | 0.108 | 4.006 | 5.7 | 3.900 | 0.330 | −0.383 |
| pentyloxyacetophenone | | | | | | | |
| n,n-dimethylacetamide | 3.974 | 0.155 | −0.746 | 4.5 | 9.400 | 0.161 | −0.383 |
| furfural | 4.678 | 0.291 | 0.731 | 5.8 | 5.100 | 0.304 | −0.382 |
| diethylmalonate | 3.183 | 0.276 | 0.703 | 5.6 | 8.300 | 0.435 | −0.377 |
| 1-(azepan-1-yl)butan- | 3.958 | 0.098 | 2.357 | 4.9 | 3.700 | 0.251 | −0.377 |
| 1-one | | | | | | | |
| p-methoxyvalerophenone | 4.488 | 0.116 | 3.334 | 4.5 | 4.400 | 0.399 | −0.373 |
| n,n-diethylbenzamide | 4.217 | 0.094 | 1.498 | 4.3 | 3.800 | 0.221 | −0.371 |
| 4,4- | 3.888 | 0.088 | 3.194 | 5.6 | 3.300 | 0.121 | −0.370 |
| dimethylnaphthalen- | | | | | | | |
| 1(4h)-one | | | | | | | |
| gamma-decalactone | 4.709 | 0.134 | 2.385 | 6.3 | 4.500 | 0.407 | −0.368 |
| piperitone | 3.802 | 0.092 | 2.411 | 6.8 | 3.500 | 0.220 | −0.364 |
| ethylacetoacetate | 4.349 | 0.272 | 0.716 | 5.0 | 8.300 | 0.391 | −0.364 |
| 1-hexylimidazole | 3.921 | 0.092 | 2.447 | 5.6 | 4.200 | 0.427 | −0.362 |
| (−)-(3s,3as,6r,7as)- | 4.662 | 0.149 | 1.767 | 6.0 | 3.900 | 0.234 | −0.360 |
| perhydro-3,6-dimethyl- | | | | | | | |
| 2-benzo[b]furanone | | | | | | | |
| 4-heptanone | 2.757 | 0.109 | 1.968 | 6.8 | 4.900 | 0.405 | −0.358 |
| Pentanedioicaciddimethyl- | 3.109 | 0.274 | 0.620 | 5.6 | 8.300 | 0.439 | −0.356 |
| ester | | | | | | | |
| 4-(benzyloxy)-4- | 3.301 | 0.104 | 2.685 | 7.5 | 3.500 | 0.255 | −0.356 |
| methylpentan-2-one | | | | | | | |
| 3,3-dimethyl-1- | 4.312 | 0.112 | 2.268 | 6.4 | 4.100 | 0.362 | −0.355 |
| phenoxybutan-2-one | | | | | | | |
| Molinate | 2.860 | 0.211 | 3.210 | 3.4 | 4.400 | 0.276 | −0.353 |
| 7-methoxy-2,2- | 2.815 | 0.086 | 3.450 | 6.4 | 4.600 | 0.310 | −0.351 |
| dimethylchromene | | | | | | | |
| propiophenone | 3.126 | 0.110 | 2.196 | 5.3 | 3.800 | 0.319 | −0.344 |
| ethyl2-benzoyl-3- | 4.628 | 0.162 | 3.097 | 6.2 | 4.000 | 0.301 | −0.341 |
| methylbutanoate | | | | | | | |
| n,n-diethyl-2- | 3.965 | 0.082 | 2.868 | 6.2 | 3.500 | 0.200 | −0.340 |
| methylcyclohexane-1- | | | | | | | |
| carboxamide | | | | | | | |
| 5-methyl-5-propyl-1,3- | 5.574 | 0.188 | 1.587 | 6.6 | 4.400 | 0.182 | −0.337 |
| dioxan-2-one | | | | | | | |
| 3-methyl-5-(2- | 6.884 | 0.253 | −0.581 | 3.8 | 5.800 | 0.293 | −0.332 |
| oxopropyl)oxolan-2-one | | | | | | | |
| 1-(azepan-1-yl)pentan- | 3.949 | 0.090 | 2.889 | 5.0 | 3.700 | 0.309 | −0.327 |
| 1-one | | | | | | | |
| 2-(2-ethoxyethoxy)- | 3.646 | 0.205 | 0.091 | 7.0 | 9.200 | 0.320 | −0.325 |
| ethanolacetate | | | | | | | |
| efetozole | 3.930 | 0.083 | 1.994 | 6.1 | 3.400 | 0.204 | −0.324 |
| methyl6- | 2.376 | 0.171 | 1.103 | 4.1 | 6.100 | 0.405 | −0.323 |
| (diethylamino)-6- | | | | | | | |
| oxohexanoate | | | | | | | |
| 5-undecanolide | 4.330 | 0.123 | 2.949 | 6.9 | 4.000 | 0.391 | −0.322 |
| methyltuberatee | 4.657 | 0.132 | 2.345 | 6.9 | 4.000 | 0.323 | −0.319 |
| 2-ethoxyethylbenzoate | 2.802 | 0.162 | 2.311 | 5.3 | 4.500 | 0.403 | −0.319 |
| 3,4-dihydro-2(1h)- | 2.713 | 0.113 | 1.726 | 4.7 | 4.400 | 0.253 | −0.317 |
| naphthalenone | | | | | | | |
| 1-methoxy-3-(4- | 2.832 | 0.079 | 3.885 | 6.0 | 4.700 | 0.396 | −0.314 |
| methylphenoxy)benzene | | | | | | | |
| n,n-dihexylacetamide | 3.980 | 0.067 | 4.567 | 6.4 | 3.900 | 0.325 | −0.312 |
| dihydroactinidiolide | 5.400 | 0.127 | 2.259 | 6.0 | 3.900 | 0.116 | −0.309 |
| 1-pentanoylpiperidine | 3.995 | 0.098 | 2.325 | 4.8 | 3.700 | 0.356 | −0.302 |
| propan-2-yl6- | 2.327 | 0.170 | 0.919 | 4.0 | 6.800 | 0.441 | −0.301 |
| (dimethylamino)-6- | | | | | | | |
| oxohexanoate | | | | | | | |
| 5,5-dimethyl-4-(3- | 5.832 | 0.201 | 0.187 | 5.4 | 4.600 | 0.241 | −0.295 |
| oxobutyl)oxolan-2-one | | | | | | | |
| 1-octylpyrrolidin-2- | 4.156 | 0.084 | 3.321 | 7.2 | 4.100 | 0.428 | −0.291 |
| one | | | | | | | |
| gamma-undecalactone | 4.648 | 0.123 | 2.916 | 6.8 | 4.200 | 0.422 | −0.291 |
| 4- | 2.376 | 0.148 | 2.746 | 5.1 | 5.900 | 0.418 | −0.290 |
| ethoxyphenethylacetate | | | | | | | |
| 2-hexanoylcyclohexan- | 4.257 | 0.151 | 2.208 | 5.4 | 3.700 | 0.389 | −0.284 |
| 1-one | | | | | | | |
| gamma- | 4.739 | 0.118 | 2.925 | 6.6 | 4.100 | 0.373 | −0.281 |
| methyldecalactone | | | | | | | |
| 1-(azepan-1-yl)-3- | 3.957 | 0.089 | 2.705 | 5.7 | 3.300 | 0.268 | −0.271 |
| methylbutan-1-one | | | | | | | |
| methyldihydrojasmonate | 2.625 | 0.167 | 2.496 | 5.7 | 4.600 | 0.328 | −0.267 |
| p-methoxypivalophenone | 4.520 | 0.110 | 2.968 | 5.5 | 3.700 | 0.311 | −0.264 |
| 2-acetyl-4-tert- | 4.280 | 0.140 | 1.803 | 6.4 | 3.000 | 0.216 | −0.257 |
| butylcyclohexan-1-one | | | | | | | |
| 4,4-dibutyl-gamma- | 4.588 | 0.109 | 3.457 | 7.2 | 3.600 | 0.272 | −0.256 |
| butyrolactone | | | | | | | |
| 4-ethyl-2,6- | 3.923 | 0.181 | 1.763 | 4.4 | 9.800 | 0.151 | −0.251 |
| dimethoxyphenol | | | | | | | |
| n,n- | 3.964 | 0.089 | 2.376 | 5.8 | 3.100 | 0.240 | −0.251 |
| diethylcyclohexanecarbox- | | | | | | | |
| amide | | | | | | | |
| 5-dodecanolide | 4.334 | 0.113 | 3.480 | 7.2 | 3.800 | 0.416 | −0.250 |
| 1-hexanoylpiperidine | 4.004 | 0.090 | 2.856 | 5.1 | 3.600 | 0.386 | −0.247 |
| 1-heptyl-1h-imidazole | 3.926 | 0.084 | 2.979 | 6.0 | 3.800 | 0.446 | −0.247 |
| 2- | 2.909 | 0.149 | 2.659 | 6.5 | 3.800 | 0.387 | −0.237 |
| isopropoxyethylbenzoate | | | | | | | |
| butanoicacid, anhydride | 4.897 | 0.226 | 1.642 | 6.7 | 4.500 | 0.433 | −0.231 |
| methylacetoacetate | 4.299 | 0.303 | 0.185 | 4.9 | 8.900 | 0.231 | −0.231 |
| Safraleine | 3.344 | 0.085 | 3.624 | 6.6 | 2.500 | 0.131 | −0.228 |
| 5-hexyl-4- | 4.717 | 0.122 | 2.877 | 7.3 | 3.800 | 0.369 | −0.227 |
| methyldihydrofuran- | | | | | | | |
| 2(3h)-one | | | | | | | |
| phenoxyacetone | 2.275 | 0.155 | 1.040 | 3.1 | 5.900 | 0.370 | −0.225 |
| 1-propoxy-2-propanol | 3.061 | 0.187 | 0.613 | 6.6 | 9.200 | 0.399 | −0.221 |
| eptam(eptc) | 2.870 | 0.188 | 3.368 | 5.2 | 3.300 | 0.182 | −0.221 |
| 1,2-dimethoxy-4- | 2.221 | 0.100 | 2.415 | 4.1 | 5.700 | 0.173 | −0.219 |
| methylbenzene | | | | | | | |
| Tetrahydrofurfurylpropionate | 2.273 | 0.200 | 0.688 | 5.9 | 6.200 | 0.388 | −0.212 |
| 2-pyrrolidon | 4.277 | 0.312 | −1.015 | 2.8 | 9.000 | 0.195 | −0.212 |
| 2-methoxypropylacetate | 2.192 | 0.209 | 0.265 | 7.0 | 6.700 | 0.304 | −0.208 |
| n-acetylcaprolactam | 7.653 | 0.210 | 1.182 | 3.1 | 4.800 | 0.171 | −0.208 |
| gamma-dodecalactone | 4.640 | 0.113 | 3.447 | 7.4 | 3.900 | 0.436 | −0.205 |
| methyl_diantilis | 3.920 | 0.183 | 1.457 | 3.7 | 9.800 | 0.221 | −0.205 |
| n- | 4.452 | 0.076 | 3.543 | 6.0 | 3.000 | 0.126 | −0.201 |
| isopentylpropionanilide | | | | | | | |
| pentylpiperidine-1- | 2.706 | 0.124 | 2.956 | 4.2 | 4.300 | 0.406 | −0.199 |
| carboxylate | | | | | | | |
| 1-(2-ethylpiperidin-1- | 3.957 | 0.090 | 2.817 | 6.5 | 2.700 | 0.216 | −0.197 |
| yl)butan-1-one | | | | | | | |
| propan-2-yl2-propan-2- | 2.960 | 0.137 | 3.799 | 7.0 | 2.900 | 0.218 | −0.196 |
| yloxybenzoate | | | | | | | |
| N,N-dibutylpentanamide | 3.955 | 0.071 | 4.036 | 7.2 | 2.700 | 0.166 | −0.195 |
| 2,3-dihydro-2,2- | 2.620 | 0.165 | 2.226 | 4.8 | 9.000 | 0.191 | −0.192 |
| dimethyl-7- | | | | | | | |
| hydroxybenzofuran | | | | | | | |
| 3-methyl-2-oxazolidone | 5.813 | 0.253 | −0.388 | 3.0 | 8.700 | 0.160 | −0.192 |
| 4,6-dimethylpyrimidine | 2.167 | 0.188 | 0.587 | 2.9 | 5.900 | 0.217 | −0.189 |
| 2-heptanone | 2.780 | 0.109 | 1.968 | 7.3 | 4.100 | 0.413 | −0.182 |
| 2-2-(2- | 2.518 | 0.183 | −0.472 | 6.7 | 8.600 | 0.262 | −0.181 |
| methoxypropoxy)propoxy- | | | | | | | |
| 1-propanol | | | | | | | |
| 1,2,3,4,5,6,7,8- | 2.739 | 0.067 | 4.781 | 7.0 | 3.800 | 0.168 | −0.178 |
| octahydro-2,8,8- | | | | | | | |
| trimethylnaphthalene- | | | | | | | |
| 2-carbaldehyde | | | | | | | |
| Cycloate | 2.811 | 0.181 | 3.833 | 4.8 | 3.400 | 0.242 | −0.177 |
| 4-methylquinoline | 2.281 | 0.082 | 2.544 | 5.5 | 5.400 | 0.192 | −0.171 |
| 5-nonanone | 2.738 | 0.089 | 3.031 | 6.6 | 4.400 | 0.442 | −0.170 |
| n,n-dipentylbutanamide | 3.967 | 0.067 | 4.567 | 7.2 | 2.700 | 0.192 | −0.169 |
| 3-dimethylamino-2- | 2.939 | 0.086 | 2.090 | 7.0 | 3.500 | 0.325 | −0.167 |
| methylpropiophenone | | | | | | | |
| 2-ethyl-1- | 3.949 | 0.083 | 3.348 | 6.5 | 2.800 | 0.273 | −0.167 |
| pentanoylpiperidine | | | | | | | |
| vanillyl-ethyl-ether | 3.240 | 0.183 | 1.457 | 3.7 | 9.800 | 0.279 | −0.165 |
| N,N-dibutylhexanamide | 3.964 | 0.067 | 4.567 | 7.2 | 2.700 | 0.201 | −0.164 |
| 2-ethylhexyllactate | 2.594 | 0.185 | 2.817 | 7.0 | 8.600 | 0.382 | −0.162 |
| tripropyleneglycolmono- | 2.571 | 0.183 | −0.472 | 6.7 | 8.600 | 0.359 | −0.162 |
| methylether | | | | | | | |
| Magnolione | 2.748 | 0.139 | 2.331 | 5.8 | 3.600 | 0.307 | −0.152 |
| 1-octylimidazole | 3.921 | 0.078 | 3.510 | 6.6 | 3.400 | 0.453 | −0.150 |
| butylformate | 4.406 | 0.199 | 1.361 | 7.0 | 9.200 | 0.450 | −0.146 |
| butylate | 2.852 | 0.162 | 4.063 | 6.6 | 2.700 | 0.153 | −0.146 |
| 5-ethyl-2-(2-furyl)-4- | 2.603 | 0.127 | 3.648 | 7.5 | 3.800 | 0.207 | −0.145 |
| propyl-m-dioxane | | | | | | | |
| 1-methoxy-4-(2- | 2.201 | 0.118 | 1.529 | 4.8 | 5.900 | 0.355 | −0.145 |
| methoxyethoxymethyl)benzene | | | | | | | |
| hexylpiperidine-1- | 2.720 | 0.115 | 3.487 | 4.7 | 4.100 | 0.422 | −0.143 |
| carboxylate | | | | | | | |
| 4-propylcyclohexanone | 2.823 | 0.102 | 2.317 | 6.1 | 3.600 | 0.342 | −0.140 |
| 2,5,8,11,14,17- | 2.134 | 0.167 | −1.872 | 7.2 | 6.900 | 0.395 | −0.139 |
| hexaoxaoctadecane | | | | | | | |
| ethyln,n- | 2.312 | 0.183 | 1.304 | 4.3 | 5.400 | 0.369 | −0.137 |
| diethylsuccinamate | | | | | | | |
| Ethyldipentylcarbamate | 2.683 | 0.098 | 5.159 | 6.1 | 3.600 | 0.198 | −0.134 |
| 2-butoxyethyl4- | 2.625 | 0.129 | 3.834 | 6.4 | 4.000 | 0.323 | −0.133 |
| methylbenzoate | | | | | | | |
| 4′-pentylacetophenone | 3.246 | 0.074 | 4.250 | 6.5 | 3.200 | 0.412 | −0.132 |
| Vernolate | 2.859 | 0.176 | 3.899 | 5.8 | 2.900 | 0.224 | −0.129 |
| 2- | 2.917 | 0.107 | 2.185 | 6.7 | 2.900 | 0.246 | −0.129 |
| cyclopentylcyclopentanone | | | | | | | |
| 2-butoxyethylbenzoate | 2.591 | 0.139 | 3.374 | 6.2 | 4.100 | 0.331 | −0.128 |
| trimethoxymethane | 1.980 | 0.190 | 0.551 | 6.7 | 6.400 | 0.119 | −0.123 |
| Phenoyethylpropionate | 2.152 | 0.163 | 2.142 | 5.1 | 6.200 | 0.406 | −0.120 |
| 4′- | 3.254 | 0.080 | 3.535 | 7.0 | 2.800 | 0.358 | −0.109 |
| isobutylacetophenone | | | | | | | |
| 2-methylindole | 2.098 | 0.110 | 2.603 | 4.3 | 6.200 | 0.307 | −0.108 |
| Rosalyptus | 3.955 | 0.075 | 3.320 | 7.5 | 2.500 | 0.263 | −0.108 |
| 2-methoxy-4- | 2.546 | 0.151 | 2.709 | 4.4 | 9.000 | 0.248 | −0.102 |
| propylphenol | | | | | | | |
| 3,5-bis(2- | 4.352 | 0.128 | 3.911 | 7.1 | 2.100 | 0.209 | −0.095 |
| methylpropyl)cyclohexane- | | | | | | | |
| 1,2-dione | | | | | | | |
| 2,4-diethoxy-6- | 2.141 | 0.203 | 2.593 | 3.0 | 5.500 | 0.165 | −0.091 |
| methylpyrimidine | | | | | | | |
| ethyl-2- | 2.878 | 0.258 | 2.766 | 2.0 | 9.200 | 0.288 | −0.087 |
| hydroxybenzoate | | | | | | | |
| p-ethoxybenzaldehyde | 2.101 | 0.155 | 2.231 | 1.7 | 6.200 | 0.383 | −0.087 |
| n,n-dimethyl4- | 5.531 | 0.135 | 0.960 | 1.9 | 9.200 | 0.337 | −0.087 |
| methoxybenzamide | | | | | | | |
| glycerol-triacetate | 2.898 | 0.319 | −0.238 | 5.5 | 9.000 | 0.268 | −0.084 |
| p-hexylacetophenone | 3.243 | 0.069 | 4.782 | 6.8 | 3.000 | 0.419 | −0.080 |
| N,N-bis(1- | 4.063 | 0.075 | 2.723 | 6.6 | 2.400 | 0.270 | −0.072 |
| methylethyl)- | | | | | | | |
| benzeneacetamide | | | | | | | |
| 3-ethylundecane-4,6- | 5.455 | 0.126 | 4.406 | 7.3 | 3.700 | 0.405 | −0.072 |
| dione | | | | | | | |
| propyl4- | 2.319 | 0.195 | 0.773 | 3.2 | 8.000 | 0.429 | −0.063 |
| (dimethylamino)-4- | | | | | | | |
| oxobutanoate | | | | | | | |
| chinoline | 2.115 | 0.095 | 2.084 | 5.8 | 5.700 | 0.244 | −0.059 |
| petunia | 2.977 | 0.252 | 2.694 | 2.9 | 9.600 | 0.223 | −0.058 |
| N,N- | 3.959 | 0.071 | 4.036 | 7.5 | 2.500 | 0.327 | −0.057 |
| dipropylheptanamide | | | | | | | |
| 4-methylpyridine | 2.034 | 0.112 | 1.186 | 3.9 | 5.900 | 0.224 | −0.051 |
| 4-pentylcyclohexanone | 2.820 | 0.084 | 3.380 | 6.5 | 3.500 | 0.407 | −0.044 |
| 4- | 2.247 | 0.251 | 0.430 | 7.1 | 7.800 | 0.286 | −0.043 |
| pyridinecarboxaldehyde | | | | | | | |
| oxolan-2- | 2.346 | 0.143 | 2.813 | 7.3 | 5.000 | 0.456 | −0.038 |
| ylmethylheptanoate | | | | | | | |
| Nectaryl | 2.853 | 0.068 | 4.259 | 7.3 | 3.200 | 0.333 | −0.025 |
| o-i-propoxyphenol | 2.449 | 0.169 | 2.065 | 4.3 | 9.000 | 0.227 | −0.023 |
| octanophenon | 3.136 | 0.070 | 4.853 | 7.3 | 2.900 | 0.442 | −0.022 |
| 2-benzyl-4-methyl-1,3- | 2.405 | 0.089 | 2.234 | 6.9 | 4.500 | 0.304 | −0.018 |
| dioxane | | | | | | | |
| ethylbenzoate | 2.030 | 0.156 | 2.727 | 4.2 | 6.000 | 0.339 | −0.013 |
| florol | 1.970 | 0.138 | 2.004 | 6.0 | 7.300 | 0.276 | −0.011 |
| 3- | 2.678 | 0.156 | 2.805 | 7.0 | 3.300 | 0.366 | −0.006 |
| (diethylamino)propiophenone | | | | | | | |
| benzylacetoacetate | 1.953 | 0.205 | 2.033 | 3.8 | 6.400 | 0.225 | −0.005 |
| isoamylbenzoate | 2.740 | 0.118 | 4.137 | 7.2 | 3.200 | 0.386 | −0.001 |
| 4-methylphenol | 1.260 | 0.162 | 1.940 | 39.4 | 10.800 | 0.297 | 1.672 |
| glycerol | 4.075 | 0.556 | −2.321 | 19.7 | 27.200 | 0.296 | 1.428 |
| glycol | 2.277 | 0.501 | −1.688 | 18.7 | 26.000 | 0.250 | 1.975 |
| 4-hydroxymethyl-1,3- | 6.167 | 0.485 | −1.638 | 18.6 | 17.400 | 0.254 | 1.559 |
| dioxolan-2-one | | | | | | | |
| 1,3-propanediol | 2.639 | 0.412 | −1.040 | 16.4 | 23.200 | 0.415 | 1.715 |
| methylbutane | 0.013 | 0.000 | 3.228 | 15.8 | 0.000 | 0.183 | 2.016 |
| 2,2,4-trimethylpentane | 0.010 | 0.000 | 4.457 | 15.4 | 0.000 | 0.163 | 2.003 |
| 2,2,4,4- | 0.012 | 0.000 | 4.806 | 15.4 | 0.000 | 0.126 | 1.981 |
| tetramethylpentane | | | | | | | |
| 2,2-dimethylbutane | 0.011 | 0.000 | 3.578 | 15.4 | 0.000 | 0.069 | 1.946 |
| 2,2,3-trimethyl-butane | 0.018 | 0.000 | 3.925 | 15.4 | 0.000 | 0.050 | 1.936 |
| 2,2,3,3- | 0.011 | 0.000 | 4.806 | 15.3 | 0.000 | 0.085 | 1.956 |
| tetramethylpentane | | | | | | | |
| 2,2,5,5- | 0.000 | 0.000 | 5.337 | 15.2 | 0.000 | 0.238 | 2.048 |
| tetramethylhexane | | | | | | | |
| 2,2-dimethylpentane | 0.002 | 0.000 | 4.109 | 15.2 | 0.000 | 0.196 | 2.022 |
| 2,2,3,3- | 0.002 | 0.000 | 5.337 | 15.1 | 0.000 | 0.165 | 2.003 |
| tetramethylhexane | | | | | | | |
| 2,3-dimethylbutane | 0.000 | 0.000 | 3.576 | 15.1 | 0.000 | 0.138 | 1.986 |
| 2,2,3-trimethylpentane | 0.014 | 0.000 | 4.457 | 15.1 | 0.000 | 0.133 | 1.985 |
| 2,2,3,4- | 0.003 | 0.000 | 4.804 | 15.1 | 0.000 | 0.111 | 1.970 |
| tetramethylpentane | | | | | | | |
| Pentane | 0.009 | 0.000 | 3.412 | 15.0 | 0.000 | 0.386 | 2.148 |
| 3,3-dimethylpentane | 0.021 | 0.361 | 4.109 | 15.0 | 0.000 | 0.175 | 2.085 |
| 2,2,5-trimethylhexane | 0.017 | 0.000 | 4.988 | 15.0 | 0.000 | 0.264 | 2.068 |
| 2,3,3-trimethylpentane | 0.020 | 0.000 | 4.457 | 15.0 | 0.000 | 0.135 | 1.987 |
| 2,3,3,4- | 0.019 | 0.000 | 4.804 | 15.0 | 0.000 | 0.087 | 1.958 |
| tetramethylpentane | | | | | | | |
| 3-ethyl-2,2-dimethyl- | 0.014 | 0.000 | 4.988 | 15.0 | 0.000 | 0.085 | 1.956 |
| pentane | | | | | | | |
| 2,2-dimethylhexane | 0.011 | 0.000 | 4.640 | 14.9 | 0.000 | 0.287 | 2.082 |
| 2,2,4,6,6- | 0.015 | 0.000 | 6.216 | 14.9 | 0.000 | 0.271 | 2.072 |
| pentamethylheptane | | | | | | | |
| 2,4,4-trimethylhexane | 0.013 | 0.000 | 4.988 | 14.9 | 0.000 | 0.241 | 2.052 |
| 2,2,4-trimethylhexane | 0.015 | 0.000 | 4.988 | 14.9 | 0.000 | 0.238 | 2.051 |
| 2,4-dimethylpentane | 0.010 | 0.000 | 4.107 | 14.9 | 0.000 | 0.210 | 2.033 |
| 2,2,6-trimethylheptane | 0.013 | 0.000 | 5.519 | 14.7 | 0.000 | 0.334 | 2.113 |
| 2,5-dimethylhexane | 0.000 | 0.000 | 4.638 | 14.7 | 0.000 | 0.309 | 2.095 |
| 2-methylpentane | 0.016 | 0.000 | 3.760 | 14.7 | 0.000 | 0.282 | 2.080 |
| 3,3-dimethylhexane | 0.012 | 0.000 | 4.640 | 14.7 | 0.000 | 0.269 | 2.070 |
| 2,3,4-trimethylpentane | 0.995 | 0.000 | 4.454 | 14.7 | 0.000 | 0.166 | 1.975 |
| 2,2-dimethylheptane | 0.002 | 0.000 | 5.172 | 14.6 | 0.000 | 0.353 | 2.124 |
| 2-methylhexane | 0.013 | 0.000 | 4.291 | 14.6 | 0.000 | 0.349 | 2.123 |
| 2,4-dimethylhexane | 0.001 | 0.000 | 4.638 | 14.6 | 0.000 | 0.281 | 2.076 |
| 3-methylpentane | 0.016 | 0.000 | 3.760 | 14.6 | 0.000 | 0.266 | 2.069 |
| 2,3,5-trimethylhexane | 0.011 | 0.000 | 4.986 | 14.6 | 0.000 | 0.255 | 2.061 |
| 2-methyl-3- | 0.001 | 0.000 | 4.638 | 14.6 | 0.000 | 0.118 | 1.974 |
| ethylpentane | | | | | | | |
| 3-ethyl-2,4- | 0.015 | 0.000 | 4.986 | 14.6 | 0.000 | 0.075 | 1.950 |
| dimethylpentane | | | | | | | |
| hexane | 0.000 | 0.000 | 3.944 | 14.5 | 0.000 | 0.420 | 2.170 |
| 2,6-dimethyl-heptane | 0.010 | 0.000 | 5.170 | 14.5 | 0.000 | 0.362 | 2.132 |
| 3-methyl-hexane | 0.013 | 0.000 | 4.291 | 14.5 | 0.000 | 0.337 | 2.115 |
| 3-ethylpentane | 0.013 | 0.000 | 4.291 | 14.5 | 0.000 | 0.147 | 1.994 |
| 3-ethyl-3- | 0.011 | 0.000 | 4.640 | 14.5 | 0.000 | 0.092 | 1.960 |
| methylpentane | | | | | | | |
| 2,7-dimethyloctane | 0.026 | 0.000 | 5.701 | 14.4 | 0.000 | 0.398 | 2.159 |
| 2-methylheptane | 0.016 | 0.000 | 4.822 | 14.4 | 0.000 | 0.393 | 2.154 |
| 3,3-diethylpentane | 0.000 | 0.000 | 5.172 | 14.4 | 0.000 | 0.080 | 1.951 |
| 3-methylheptane | 0.016 | 0.000 | 4.822 | 14.3 | 0.000 | 0.382 | 2.146 |
| 2-methyloctane | 0.013 | 0.000 | 5.354 | 14.2 | 0.000 | 0.420 | 2.172 |
| 4-methylheptane | 0.016 | 0.000 | 4.822 | 14.2 | 0.000 | 0.371 | 2.139 |
| 3-ethylheptane | 0.013 | 0.000 | 5.354 | 14.2 | 0.000 | 0.308 | 2.096 |
| propyleneglycol | 2.270 | 0.407 | −1.341 | 14.1 | 21.300 | 0.105 | 1.820 |
| 2-methyl-nonane | 0.016 | 0.000 | 5.885 | 14.1 | 0.000 | 0.439 | 2.186 |
| n-heptane | 0.009 | 0.000 | 4.475 | 14.1 | 0.000 | 0.437 | 2.183 |
| 3-methyloctane | 0.013 | 0.000 | 5.354 | 14.1 | 0.000 | 0.414 | 2.168 |
| 4-methyloctane | 0.013 | 0.000 | 5.354 | 14.1 | 0.000 | 0.405 | 2.162 |
| 2-methyldecane | 0.013 | 0.000 | 6.416 | 14.0 | 0.000 | 0.452 | 2.194 |
| 3-methyl-nonane | 0.016 | 0.000 | 5.885 | 14.0 | 0.000 | 0.434 | 2.182 |
| 1,1,3,3- | 0.014 | 0.000 | 4.887 | 14.0 | 0.000 | 0.127 | 1.982 |
| tetramethylcyclopentane | | | | | | | |
| 1,3-butanediol | 0.704 | 0.346 | −0.692 | 14.0 | 20.900 | 0.303 | 3.050 |
| octane | 0.000 | 0.000 | 5.006 | 13.9 | 0.000 | 0.452 | 2.192 |
| 4-methyldecane | 0.013 | 0.000 | 6.416 | 13.9 | 0.000 | 0.443 | 2.188 |
| 5-methyl-nonane | 0.016 | 0.000 | 5.885 | 13.9 | 0.000 | 0.427 | 2.177 |
| 4-methyl-nonane | 0.016 | 0.000 | 5.885 | 13.9 | 0.000 | 0.427 | 2.177 |
| 1,1- | 0.015 | 0.000 | 3.854 | 13.9 | 0.000 | 0.084 | 1.956 |
| dimethylcyclopentane | | | | | | | |
| 1,1,2- | 0.022 | 0.000 | 4.346 | 13.9 | 0.000 | 0.053 | 1.938 |
| trimethylcyclopentane | | | | | | | |
| 1,4-butadiol | 0.000 | 0.350 | −1.023 | 13.9 | 20.900 | 0.437 | 3.101 |
| 1,1,2- | 0.023 | 0.000 | 4.911 | 13.8 | 0.000 | 0.078 | 1.954 |
| trimethylcyclohexane | | | | | | | |
| n-decane | 0.000 | 0.000 | 6.069 | 13.8 | 0.000 | 0.468 | 2.203 |
| n-nonane | 0.009 | 0.000 | 5.538 | 13.8 | 0.000 | 0.461 | 2.199 |
| isobutylcyclopentane | 0.019 | 0.000 | 4.724 | 13.8 | 0.000 | 0.290 | 2.086 |
| (1-methylethyl)- | 0.006 | 0.000 | 4.192 | 13.8 | 0.000 | 0.231 | 2.045 |
| cyclopentane | | | | | | | |
| tert-butylcyclohexane | 0.014 | 0.000 | 5.106 | 13.8 | 0.000 | 0.188 | 2.019 |
| pentadecane | 0.009 | 0.000 | 8.726 | 13.7 | 0.000 | 0.485 | 2.217 |
| Tridecane | 0.009 | 0.000 | 7.663 | 13.7 | 0.000 | 0.481 | 2.213 |
| 1,1,3- | 0.017 | 0.000 | 4.346 | 13.7 | 0.000 | 0.158 | 2.001 |
| trimethylcyclopentane | | | | | | | |
| 1,1,3- | 0.008 | 0.000 | 4.911 | 13.7 | 0.000 | 0.118 | 1.975 |
| trimethylcyclohexane | | | | | | | |
| nonadecane | 0.009 | 0.000 | 10.851 | 13.6 | 0.000 | 0.491 | 2.221 |
| heptadecane | 0.009 | 0.000 | 9.788 | 13.6 | 0.000 | 0.489 | 2.219 |
| Octadecane | 0.000 | 0.000 | 10.320 | 13.6 | 0.000 | 0.490 | 2.218 |
| ethylcyclopentane | 0.011 | 0.000 | 3.845 | 13.6 | 0.000 | 0.239 | 2.051 |
| Dodecane | 0.000 | 0.000 | 7.132 | 13.5 | 0.000 | 0.478 | 2.210 |
| n-undecane | 0.009 | 0.000 | 6.600 | 13.5 | 0.000 | 0.473 | 2.208 |
| propylcyclopentane | 0.015 | 0.000 | 4.376 | 13.5 | 0.000 | 0.334 | 2.114 |
| isobutylcyclohexane | 0.013 | 0.000 | 5.288 | 13.5 | 0.000 | 0.285 | 2.081 |
| isopropylcyclohexane | 0.009 | 0.000 | 4.757 | 13.5 | 0.000 | 0.228 | 2.044 |
| 1-ethyl-1- | 0.016 | 0.000 | 4.386 | 13.5 | 0.000 | 0.146 | 1.994 |
| methylcyclopentane | | | | | | | |
| 2,3,3-trimethyl-1- | 0.170 | 0.000 | 3.620 | 13.5 | 1.400 | 0.057 | 1.809 |
| butene | | | | | | | |
| 2,4,4-trimethyl-1- | 0.213 | 0.000 | 4.151 | 13.4 | 1.400 | 0.143 | 1.866 |
| pentene | | | | | | | |
| n-hexylcyclopentane | 0.009 | 0.000 | 5.970 | 13.4 | 0.000 | 0.428 | 2.176 |
| pentylcyclopentane | 0.015 | 0.000 | 5.439 | 13.4 | 0.000 | 0.410 | 2.165 |
| 1-isopropyl-4- | 0.016 | 0.000 | 5.249 | 13.4 | 0.000 | 0.288 | 2.083 |
| methylcyclohexane | | | | | | | |
| trimethylaluminum | 0.000 | 0.000 | | 13.4 | 0.000 | 0.145 | 1.990 |
| n- | 0.009 | 0.000 | 10.221 | 13.4 | 0.000 | 0.483 | 2.215 |
| tetradecylcyclopentane | | | | | | | |
| tridecylcyclopentane | 0.015 | 0.000 | 9.690 | 13.4 | 0.000 | 0.481 | 2.214 |
| tetradecane | 0.000 | 0.000 | 8.194 | 13.4 | 0.000 | 0.483 | 2.214 |
| n-dodecylcyclopentane | 0.009 | 0.000 | 9.158 | 13.4 | 0.000 | 0.477 | 2.211 |
| n-decylcyclopentane | 0.009 | 0.000 | 8.096 | 13.4 | 0.000 | 0.469 | 2.205 |
| n-propylcyclohexane | 0.013 | 0.000 | 4.940 | 13.4 | 0.000 | 0.316 | 2.101 |
| ethylcyclohexane | 0.009 | 0.000 | 4.409 | 13.4 | 0.000 | 0.236 | 2.049 |
| 3,3-dimethyl-1-butene | 0.102 | 0.000 | 3.068 | 13.3 | 1.800 | 0.063 | 1.749 |
| n-hexadecane | 0.000 | 0.000 | 9.257 | 13.3 | 0.000 | 0.487 | 2.217 |
| pentene | 0.136 | 0.000 | 2.902 | 13.3 | 3.800 | 0.382 | 1.609 |
| 2,3,3-trimethyl-1- | 0.180 | 0.000 | 4.151 | 13.2 | 1.100 | 0.135 | 1.894 |
| pentene | | | | | | | |
| decylcyclohexane | 0.009 | 0.000 | 8.660 | 13.2 | 0.000 | 0.464 | 2.202 |
| pentylcyclohexane | 0.013 | 0.000 | 6.003 | 13.2 | 0.000 | 0.398 | 2.156 |
| 3,4-dicyclohexyl-2,5- | 0.026 | 0.000 | 9.452 | 13.2 | 0.000 | 0.127 | 1.984 |
| dimethylhexane | | | | | | | |
| 2-methyl-1-butene | 0.229 | 0.000 | 2.923 | 13.2 | 1.300 | 0.152 | 1.886 |
| ethanol | 1.400 | 0.285 | −0.187 | 13.1 | 19.400 | 0.288 | 2.626 |
| 3,3-dimethyl-1-pentene | 0.110 | 0.111 | 3.599 | 13.1 | 1.500 | 0.144 | 1.650 |
| 4,4-dimethyl-1-pentene | 0.124 | 0.000 | 3.599 | 13.0 | 1.900 | 0.170 | 1.802 |
| butylcyclohexane | 0.009 | 0.000 | 5.472 | 13.0 | 0.600 | 0.359 | 2.068 |
| methylcyclopentane | 0.018 | 0.000 | 3.313 | 13.0 | 1.000 | 0.175 | 1.906 |
| methylcyclohexane | 0.013 | 0.000 | 3.878 | 13.0 | 1.000 | 0.170 | 1.902 |
| Decahydronaphthalene | 0.000 | 0.000 | 4.932 | 13.0 | 0.000 | 0.211 | 2.031 |
| hexahydroindene | 0.010 | 0.000 | 4.368 | 13.0 | 0.000 | 0.198 | 2.025 |
| bicyclohexyl | 0.000 | 0.000 | 5.937 | 12.8 | 0.000 | 0.313 | 2.097 |
| cyclohexane | 0.000 | 0.000 | 3.386 | 12.8 | 0.200 | 0.106 | 1.947 |
| 2,4,4-trimethyl-2- | 0.226 | 0.000 | 4.143 | 12.8 | 1.600 | 0.161 | 1.853 |
| pentene | | | | | | | |
| 2,3-dimethyl-1-pentene | 0.227 | 0.000 | 3.802 | 12.8 | 1.500 | 0.173 | 1.873 |
| tricyclohexylmethane | 0.010 | 0.000 | 8.876 | 12.7 | 0.000 | 0.103 | 1.967 |
| butylcyclopentane | 0.013 | 0.000 | 4.908 | 12.7 | 1.000 | 0.375 | 2.035 |
| 1-hexene | 0.133 | 0.000 | 3.434 | 12.7 | 3.000 | 0.406 | 1.782 |
| 1,5-pentanediol | 2.639 | 0.304 | −0.599 | 12.6 | 19.800 | 0.450 | 1.598 |
| 2,3-dimethyl-1-butene | 0.232 | 0.000 | 3.270 | 12.5 | 1.900 | 0.081 | 1.763 |
| methylformamide | 3.498 | 0.351 | −0.598 | 12.5 | 15.900 | 0.252 | 1.048 |
| 3,3-dimethyl-1-butyne | 0.308 | 0.000 | 2.226 | 12.5 | 1.900 | 0.072 | 1.766 |
| triethyleneglycol | 0.457 | 0.323 | −1.871 | 12.5 | 18.600 | 0.338 | 3.008 |
| 3-methoxy-1,2- | 4.424 | 0.373 | −1.297 | 12.5 | 19.800 | 0.355 | 1.391 |
| propanediol | | | | | | | |
| 2,4-dimethyl-1-pentene | 0.210 | 0.000 | 3.802 | 12.5 | 1.900 | 0.203 | 1.835 |
| 1-heptene | 0.136 | 0.000 | 3.965 | 12.4 | 2.600 | 0.432 | 1.869 |
| 3-methyl-1-pentene | 0.130 | 0.000 | 3.250 | 12.4 | 2.000 | 0.227 | 1.825 |
| 3-ethyl-2-methyl-1- | 0.211 | 0.000 | 4.333 | 12.3 | 1.800 | 0.089 | 1.779 |
| pentene | | | | | | | |
| 1,4-bis(1,1- | 0.002 | 0.000 | 5.595 | 12.3 | 0.700 | 0.311 | 2.024 |
| dimethylethyl)-benzene | | | | | | | |
| Propynol | 1.473 | 0.263 | −0.381 | 12.3 | 18.800 | 0.380 | 2.576 |
| diethyleneglycol | 2.044 | 0.378 | −1.513 | 12.3 | 19.000 | 0.339 | 2.136 |
| cyclopentane | 0.011 | 0.000 | 2.821 | 12.2 | 1.800 | 0.107 | 1.761 |
| octane | 0.133 | 0.000 | 4.496 | 12.2 | 2.400 | 0.445 | 1.910 |
| methoxyaceticacid | 3.653 | 0.422 | −0.963 | 12.2 | 17.700 | 0.346 | 1.252 |
| 1-nonene | 0.136 | 0.000 | 5.028 | 12.2 | 2.200 | 0.457 | 1.950 |
| 4-methyl-1-hexene | 0.126 | 0.000 | 3.781 | 12.2 | 2.100 | 0.328 | 1.876 |
| 1,2,3,4-tetrahydro- | 0.089 | 0.000 | 6.922 | 12.1 | 0.200 | 0.132 | 1.977 |
| 1,1,3,4,4,6- | | | | | | | |
| hexamethylnaphthalene | | | | | | | |
| Acetaldehydeammonia | 1.033 | 0.537 | −1.113 | 12.1 | 19.500 | 0.104 | 2.905 |
| 1,3,5- | 0.053 | 0.000 | 6.235 | 12.1 | 0.400 | 0.107 | 1.936 |
| triisopropylbenzene | | | | | | | |
| 1,2,2,6,6- | 0.640 | 0.014 | 3.390 | 12.1 | 1.700 | 0.065 | 1.777 |
| pentamethylpiperidine | | | | | | | |
| 1,4-diethylbenzene | 0.001 | 0.000 | 4.201 | 12.1 | 0.600 | 0.343 | 2.056 |
| 2-methyl-2-butene | 0.149 | 0.000 | 2.915 | 12.1 | 2.900 | 0.206 | 1.670 |
| isoprene | 0.155 | 0.000 | 2.413 | 12.1 | 4.100 | 0.207 | 1.432 |
| 4-methyl-1-pentene | 0.136 | 0.000 | 3.250 | 12.1 | 2.500 | 0.267 | 1.775 |
| 1-tetradecene | 0.133 | 0.000 | 7.684 | 12.1 | 1.900 | 0.482 | 2.011 |
| 3-ethyl-1-pentene | 0.118 | 0.000 | 3.781 | 12.0 | 2.300 | 0.141 | 1.725 |
| 2-methyl-3-heptene | 0.014 | 0.000 | 4.304 | 12.0 | 1.900 | 0.384 | 1.925 |
| 1-decene | 0.133 | 0.000 | 5.559 | 12.0 | 2.200 | 0.464 | 1.955 |
| 2,3,4-trimethyl-2- | 0.018 | 0.000 | 4.346 | 12.0 | 1.700 | 0.141 | 1.796 |
| pentene | | | | | | | |
| 1-nonadecene | 0.136 | 0.000 | 10.341 | 12.0 | 1.500 | 0.490 | 2.072 |
| butylbenzene | 0.136 | 0.000 | 4.272 | 11.9 | 1.100 | 0.355 | 2.029 |
| 2-ethoxy-2-methyl- | 1.680 | 0.058 | 1.678 | 11.9 | 2.700 | 0.190 | 1.060 |
| propane | | | | | | | |
| 1,2-diethylbenzene | 0.240 | 0.000 | 4.201 | 11.9 | 1.000 | 0.121 | 1.905 |
| ethanedial | 0.008 | 0.492 | −0.671 | 11.8 | 13.300 | 0.420 | 2.747 |
| cyclohexylbenzene | 0.116 | 0.000 | 4.738 | 11.8 | 1.000 | 0.312 | 2.009 |
| galaxolide | 0.857 | 0.029 | 6.232 | 11.7 | 0.700 | 0.209 | 1.224 |
| 1,2,3,4- | 0.267 | 0.000 | 4.059 | 11.7 | 0.500 | 0.186 | 2.004 |
| tetramethylbenzene | | | | | | | |
| 1,2,3,5- | 0.155 | 0.000 | 4.059 | 11.7 | 0.500 | 0.170 | 1.980 |
| tetramethylbenzene | | | | | | | |
| pentaethylbenzene | 0.141 | 0.000 | 7.175 | 11.6 | 0.700 | 0.111 | 1.920 |
| 1,3,5-trimethylbenzene | 0.001 | 0.000 | 3.599 | 11.6 | 0.600 | 0.159 | 1.938 |
| Isobutanol | 1.411 | 0.188 | 0.691 | 11.6 | 15.900 | 0.194 | 2.244 |
| peroxyaceticacid | 3.191 | 0.541 | −0.228 | 11.6 | 18.500 | 0.257 | 1.300 |
| 1,6-hexanediol | 0.000 | 0.269 | −0.068 | 11.5 | 18.500 | 0.461 | 2.959 |
| 2,6-di-tert-butyl-4- | 1.872 | 0.044 | 4.563 | 11.5 | 0.800 | 0.154 | 1.136 |
| methylpyridine | | | | | | | |
| 2,2′-(methylimino)bis- | 2.899 | 0.274 | −0.718 | 11.5 | 18.500 | 0.153 | 1.157 |
| ethanol | | | | | | | |
| Propanol | 1.413 | 0.229 | 0.344 | 11.5 | 17.400 | 0.368 | 2.505 |
| 1,3-bis(1- | 0.080 | 0.000 | 4.896 | 11.5 | 0.900 | 0.272 | 1.989 |
| methylethyl)-benzene | | | | | | | |
| 2,7- | 0.060 | 0.000 | 6.127 | 11.4 | 2.000 | 0.347 | 1.892 |
| diisopropylnaphthalene | | | | | | | |
| 1,2,3,5- | 0.144 | 0.000 | 6.184 | 11.3 | 1.400 | 0.123 | 1.844 |
| tetraethylbenzene | | | | | | | |
| tetrahydro-2,2,5,5- | 1.851 | 0.052 | 2.393 | 11.3 | 2.100 | 0.117 | 0.951 |
| tetramethylfuran | | | | | | | |
| 1-hydroxybenzotriazole | 2.763 | 0.401 | 0.320 | 11.3 | 17.700 | 0.230 | 1.395 |
| 1,5- | 0.000 | 0.000 | 6.127 | 11.3 | 2.000 | 0.259 | 1.825 |
| diisopropylnaphthalene | | | | | | | |
| 2,3-butanediol | 0.000 | 0.343 | −0.994 | 11.3 | 18.300 | 0.145 | 2.844 |
| 1,2-diisopropylbenzene | 0.193 | 0.000 | 4.896 | 11.3 | 1.100 | 0.086 | 1.866 |
| Benzene | 0.001 | 0.000 | 2.218 | 11.3 | 2.000 | 0.167 | 1.767 |
| 1-pentan-2-yl-4- | 0.041 | 0.000 | 7.021 | 11.2 | 1.300 | 0.340 | 1.979 |
| pentan-3-ylbenzene | | | | | | | |
| tetradecylbenzene | 0.136 | 0.000 | 9.586 | 11.2 | 1.800 | 0.479 | 2.023 |
| diethylether | 1.581 | 0.082 | 0.981 | 11.2 | 4.600 | 0.389 | 0.849 |
| pentadecylbenzene | 0.140 | 0.000 | 10.117 | 11.2 | 1.700 | 0.482 | 2.040 |
| ethylbenzene | 0.139 | 0.000 | 3.210 | 11.2 | 1.400 | 0.246 | 1.921 |
| 3,6-bis- | 0.002 | 0.064 | 3.537 | 11.2 | 3.000 | 0.265 | 1.557 |
| (methoxymethyl)-durene | | | | | | | |
| himachalen_gamma | 0.214 | 0.000 | 6.789 | 11.2 | 2.500 | 0.124 | 1.696 |
| 1-(1,1-dimethylethyl)- | 0.137 | 0.000 | 4.367 | 11.1 | 1.300 | 0.204 | 1.906 |
| 3-methylbenzene | | | | | | | |
| tridecylbenzene | 0.140 | 0.000 | 9.055 | 11.1 | 1.900 | 0.476 | 2.008 |
| 1-(methoxymethyl)-4- | 1.604 | 0.028 | 5.405 | 11.1 | 1.500 | 0.362 | 1.477 |
| (2,4,4- | | | | | | | |
| trimethylpentan-2- | | | | | | | |
| yl)benzene | | | | | | | |
| dodecylbenzene | 0.136 | 0.000 | 8.523 | 11.1 | 1.800 | 0.472 | 2.019 |
| 1,2,4-trimethylbenzene | 0.154 | 0.000 | 3.599 | 11.1 | 1.000 | 0.226 | 1.959 |
| 1-cyclohexyl-2- | 0.187 | 0.000 | 6.077 | 11.1 | 1.300 | 0.166 | 1.889 |
| isopropylbenzene | | | | | | | |
| 2-propanol | 1.444 | 0.226 | 0.160 | 11.1 | 16.400 | 0.111 | 2.261 |
| dl-pin-2(3)-ene | 0.108 | 0.000 | 4.372 | 11.0 | 2.200 | 0.070 | 1.695 |
| 2,6-di-tert- | 1.723 | 0.048 | 4.103 | 11.0 | 1.200 | 0.215 | 1.270 |
| butylpyridine | | | | | | | |
| 1,1′-oxybis-octane | 1.586 | 0.028 | 7.357 | 11.0 | 2.100 | 0.488 | 1.497 |
| 1,5-hexanediol | 0.704 | 0.267 | −0.252 | 11.0 | 17.800 | 0.405 | 2.937 |
| 1-(1,1-dimethylethyl)- | 0.044 | 0.000 | 4.827 | 11.0 | 1.500 | 0.163 | 1.841 |
| 3,5-dimethylbenzene | | | | | | | |
| menthylisovalerate | 1.604 | 0.090 | 5.510 | 10.9 | 2.200 | 0.237 | 1.183 |
| 1-methyl-7-(1- | 0.248 | 0.000 | 5.779 | 10.9 | 2.600 | 0.290 | 1.788 |
| methylpropyl)naphthalene | | | | | | | |
| tert-butanol | 1.493 | 0.171 | 0.509 | 10.9 | 14.700 | 0.000 | 1.948 |
| himachalen_beta | 0.258 | 0.000 | 6.779 | 10.9 | 2.800 | 0.121 | 1.649 |
| dimethoxymethane | 0.395 | 0.165 | −0.265 | 10.9 | 8.600 | 0.257 | 1.190 |
| 1,2,3,4,5,6,7,8- | 0.002 | 0.000 | 5.590 | 10.9 | 2.100 | 0.318 | 1.849 |
| octahydroanthracene | | | | | | | |
| (1,1- | 0.110 | 0.000 | 3.907 | 10.8 | 2.000 | 0.203 | 1.807 |
| dimethylethyl)benzene | | | | | | | |
| 1,2-hexanediol | 2.812 | 0.267 | 0.253 | 10.8 | 17.100 | 0.392 | 1.297 |
| cyclohexene | 0.125 | 0.000 | 2.895 | 10.8 | 2.000 | 0.121 | 1.758 |
| Perhydrofarnesylacetone | 2.780 | 0.048 | 7.261 | 10.8 | 2.000 | 0.463 | 0.344 |
| delta-cadinene | 0.195 | 0.000 | 6.540 | 10.8 | 3.000 | 0.137 | 1.616 |
| isopropylbenzene | 0.129 | 0.000 | 3.557 | 10.8 | 1.200 | 0.225 | 1.931 |
| undecylbenzene | 0.140 | 0.000 | 7.992 | 10.8 | 2.000 | 0.468 | 1.988 |
| 2,5-hexanediol | 0.000 | 0.265 | −0.328 | 10.7 | 17.600 | 0.322 | 2.826 |
| dipropyleneglycol | 2.473 | 0.274 | 0.707 | 10.7 | 17.500 | 0.299 | 1.519 |
| 1,6-dimethyl-4- | 0.112 | 0.000 | 6.227 | 10.7 | 1.400 | 0.122 | 1.839 |
| isopropyltetralin | | | | | | | |
| di-n-propylether | 1.605 | 0.042 | 2.044 | 10.7 | 3.200 | 0.442 | 1.238 |
| diisopropylether | 1.621 | 0.062 | 1.676 | 10.7 | 3.200 | 0.211 | 1.033 |
| Cuparen | 0.058 | 0.000 | 6.208 | 10.7 | 1.100 | 0.235 | 1.938 |
| 1,4-bis(1- | 0.053 | 0.000 | 4.896 | 10.7 | 1.500 | 0.314 | 1.939 |
| methylethyl)-benzene | | | | | | | |
| 2,4-dimethyl-3- | 1.055 | 0.156 | 2.645 | 10.7 | 2.000 | 0.224 | 1.535 |
| thiapentane | | | | | | | |
| 1-methoxy-4-(2,4,4- | 1.615 | 0.030 | 5.582 | 10.6 | 1.800 | 0.329 | 1.401 |
| trimethylpentan-2- | | | | | | | |
| yl)benzene | | | | | | | |
| 1-ethoxybutane | 1.584 | 0.063 | 2.044 | 10.6 | 4.700 | 0.439 | 0.893 |
| decylbenzene | 0.136 | 0.000 | 7.461 | 10.6 | 2.100 | 0.461 | 1.968 |
| cycloheptane | 0.001 | 0.000 | 3.950 | 10.6 | 1.900 | 0.102 | 1.742 |
| 2-Pentanone | 2.780 | 0.141 | 0.905 | 6.525 | 4.700 | 0.325 | 2.629 |
| N,N-dimethylformamide | 3.878 | 0.026 | −1.010 | 5.977 | 11.300 | 0.201 | 2.645 |
| 2-Butanone | 2.771 | 0.164 | 0.374 | 6.034 | 5.100 | 0.241 | 2.533 |
| 4-Methylpentan-2-one | 2.780 | 0.121 | 1.253 | 8.495 | 4.100 | 0.250 | 2.670 |
| Nitrobenzene | 4.442 | 0.353 | 1.948 | 5.360 | 3.100 | 0.280 | 2.963 |
| 1,1,2,2- | 2.547 | 0.000 | 2.172 | 5.192 | 5.300 | 0.091 | 2.792 |
| Tetrachloroethane | | | | | | | |
| Acetone | 2.805 | 0.197 | −0.157 | 6.476 | 7.000 | 0.148 | 2.328 |
| Ethyl acetate | 1.669 | 0.225 | 0.708 | 7.297 | 7.200 | 0.323 | 3.540 |
| Chloroform | 1.493 | 0.000 | 1.755 | 7.127 | 5.700 | 0.148 | 3.804 |
| Toluene | 0.154 | 0.000 | 2.678 | 10.166 | 2.000 | 0.220 | 4.651 |
| Cyclohexanol | 1.449 | 0.175 | 1.341 | 8.471 | 13.500 | 0.176 | 4.078 |
| Benzene | 0.001 | 0.000 | 2.218 | 11.267 | 2.000 | 0.167 | 4.594 |
| Cyclohexane | 0.000 | 0.000 | 3.386 | 12.837 | 0.200 | 0.106 | 4.723 |
| 1-Pentanol | 1.413 | 0.164 | 1.407 | 9.178 | 13.900 | 0.429 | 4.296 |
| Water | 1.013 | 1.000 | −1.380 | 11.868 | 16.900 | 0.253 | 5.036 |
| Methanol | 1.426 | 0.373 | −0.719 | 16.850 | 22.300 | 0.327 | 5.045 |
| 1-Butanol | 1.404 | 0.191 | 0.875 | 10.525 | 15.800 | 0.401 | 4.451 |

Among the solvents in Table 1, the PVC swelling score values of Equation 1 and the solvent classifications of the following Document #1 are compared in the following Table 2 for the solvents tested for dissolution of PVC in Document #1 (Grause, J Mater Cycles Waste Manag (2017) 19:612).

TABLE 2

| | PVC Swelling | PVC swelling |
|---|---|---|
| Solvent | score | ratio |
| 2-Pentanone | 2.629 | 12.69 |
| N,N-dimethylformamide | 2.645 | 12.19 |
| 2-Butanone | 2.533 | 11.53 |
| 4-Methylpentan-2-one | 2.670 | 7.06 |
| Nitrobenzene | 2.963 | 6.55 |
| 1,1,2,2- | 2.792 | 3.29 |
| Tetrachloroethane | | |
| Acetone | 2.328 | 2.79 |
| Ethyl acetate | 3.540 | 2.38 |
| Chloroform | 3.804 | 2.27 |
| Toluene | 4.651 | 1.21 |
| Cyclohexanol | 4.078 | 1.1 |
| Benzene | 4.594 | 1.07 |
| Cyclohexane | 4.723 | 1.04 |
| 1-Pentanol | 4.296 | 1.02 |
| Water | 5.036 | 1 |
| Methanol | 5.045 | 1 |
| 1-Butanol | 4.451 | 1 |

Referring to a correlation between PVC swelling score and PVC swelling ratio, which is an experimental value of Document #1 (the ratio of the actual weight increased after putting PVC into the solvent from the dry PVC weight, showing the extent to which solvent molecules are inserted between PVCs to contribute to swelling), the root mean square (R²) appears to be 0.784. Therefore, it can be seen that PVC swelling score expresses experimental values well.

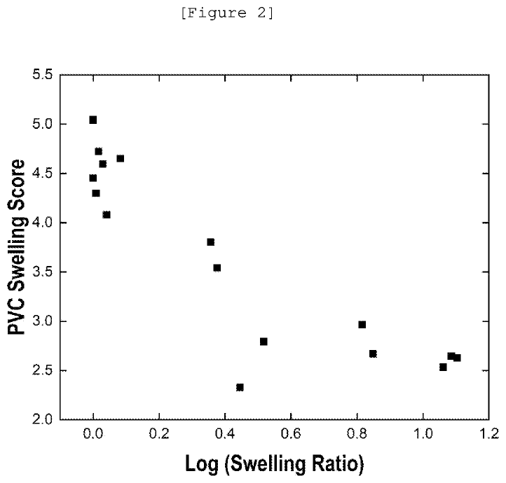

In addition, FIG. 2 illustrates the relationship between the Log value of PVC swelling ratio, which is the experimental value of Document #1, and the PVC swelling score value of the corresponding solvent.

Through Table 2, it can be confirmed that PVC Swelling Score well reflects the tendency of the PVC swelling ratio in Document #1 because the value of the PVC Swelling Score decreases as the solubility increase, and the value of the PVC swelling ratio in Document #1 increases as the amount of solvent that contributes to swelling increases.

Here, the PVC swelling ratio is the value in Table 1 of Document #1, and is a value obtained by calculating the sum of the volume of dry PVC, the volume of PVC dried after PVC is added to the solvent, and the volume of solvent that participates in swelling to calculate the proportion of the volumes of PVC swollen and solvent based on the volume of PVC.

### Experimental Examples

A solution was prepared by adding a PVC waste sample to the good solvent shown in the following Table 3 and stirring the resulting mixture at 120 rpm at room temperature for 3 hours. Thereafter, PVC was precipitated by dropping a non-solvent shown in the following Table 3 into the solution. In this case, the weight ratio of waste PVC:good solvent:non-solvent is 1:5:20.

After all non-solvents were dropped, a filtered solid was obtained by filtering the reaction solution with a filter. The filtered solid was further washed with the same non-solvent as the above non-solvent and dried to obtain recycled PVC.

TABLE 3

| | | | | | PVC |
|---|---|---|---|---|---|
| | | | Sample | Recovery | recovered |
| | Good solvent | Non-solvent | (g) | (g) | rate |
| Experimental | cyclohexanone | 2-propanol | 15 | 8.1 | 39% |
| Example 1 | | | | | |
| Experimental | | octene | 20 | 9.5 | 66% |
| Example 2 | | | | | |
| Experimental | | hexane | 20 | 10.1 | 66% |
| Example 3 | | | | | |
| Experimental | | diethylether | 20 | 5.9 | 35% |
| Example 4 | | | | | |
| Experimental | n,n- | 2-propanol | 15 | 12.6 | 50% |
| Example 5 | dimethylpropanamide | | | | |
| Experimental | | octene | 25 | 15.2 | 82% |
| Example 6 | | | | | |
| Experimental | | hexane | 25 | 13 | 74% |
| Example 7 | | | | | |
| Experimental | | diethylether | 20 | 5.6 | 41% |
| Example 8 | | | | | |
| Experimental | dichloromethane | 2-propanol | 50 | 21.8 | 22% |
| Example 9 | | | | | |
| Experimental | | octene | 20 | 6.6 | 27% |
| Example 10 | | | | | |
| Experimental | | Hexane | 20 | 3.4 | 32% |
| Example 11 | | | | | |
| Experimental | | diethylether | 20 | 1.7 | 13% |
| Example 12 | | | | | |

In Table 3, sample (g) means the weight of the PVC waste sample that was initially introduced.

PVC swelling score values for the solvents used in Table 3 are shown in the following Table 4. Referring to Table 3 with reference to the PVC swelling score values in Table 4, it can be confirmed that in the case of dichloromethane, the recovery rate is generally low because the degree of PVC swelling is lowered due to a higher PVC swelling score of dichloromethane than that of Cyclohexanone or n,n-dimethylpropanamide, and it can be confirmed that the recovery rate is generally high because n,n-dimethylpropanamide exhibits the best PVC swelling score value.

TABLE 4

| | PVC swelling | |
|---|---|---|
| | score value | Classification |
| Cyclohexanone | −0.641 | Good solvent |
| n,n- | −0.902 | Good solvent |
| dimethylpropanamide | | |
| dichloromethane | −0.290 | Good solvent |
| 2-propanol | 2.261 | Non-solvent |
| Octene | 1.910 | Non-solvent |
| Hexane | 2.170 | Non-solvent |
| diethylether | 0.849 | Non-solvent |

1. A method for screening a solvent for extracting polyvinyl chloride, comprising:
screening a solvent for extracting a polyvinyl chloride from a waste including the polyvinyl chloride using the following Equation 1:
$$PVC swelling score = {x}_{1} Dipole + {x}_{2} Asphericity + {x}_{3} dH + {x}_{4} Polar Surface Area \qquad [ Equation 1 ]$$
wherein
x₁, x₂, x₃, and x₄ are each a real number from 0 to 5,
Dipole is a dipole moment of solvent molecules,
Asphericity is an asphericity of the solvent molecules,
dH is a Hansen solubility parameter for a hydrogen bonding of the solvent molecules, and
Polar Surface Area is a fractional polar surface area.

2. The method of claim 1, further comprising: selecting any one solvent with a first PVC swelling score value of 0 or less according to Equation 1 as a good solvent for the polyvinyl chloride; and
selecting any one solvent with a second PVC swelling score value of more than 0 according to Equation 1 as a non-solvent for the polyvinyl chloride.

3. The method of claim 2, wherein a difference between the first PVC swelling score value of the good solvent and the second PVC swelling score value of the non-solvent is 1.5 or more.

4. The method of claim 2, wherein the good solvent has a boiling point of 85° C. or more.

5. The method of claim 1, wherein x₁ is 1.5, x₂ is 1.5, x₃ is 0.5, and x₄ is 0.25.

6. A method for recycling the waste comprising the polyvinyl chloride, comprising:
screening the solvent for extracting the polyvinyl chloride using the method of claim 1; and
extracting polyvinyl chloride from the waste comprising the polyvinyl chloride using the screened solvent.

7. The method of claim 6, wherein
the extracting of the polyvinyl chloride comprises:
a dissolution process of bringing the waste comprising the polyvinyl chloride into contact with a good solvent with the first PVC swelling score value of 0 or less according to Equation 1 and obtaining a polyvinyl chloride solution by dissolving the polyvinyl chloride in the waste in the good solvent; and
a precipitation process of precipitating the polyvinyl chloride from the polyvinyl chloride solution by bringing the polyvinyl chloride solution into contact with the non-solvent with the second PVC swelling score value of more than 0 according to Equation 1.

8. The method of claim 7, further comprising a separation process of separating a solid material from the polyvinyl chloride solution obtained by the dissolution process.

9. The method of claim 7, further comprising a rinsing process of rinsing the polyvinyl chloride precipitated by the precipitation process.

10. A recycled polyvinyl chloride extracted from the waste comprising the polyvinyl chloride using the solvent screened by the method of claim 1.

11. The recycled polyvinyl chloride of claim 10, wherein the recycled polyvinyl chloride comprises an additive derived from the waste.

12. A waste polyvinyl chloride recycled composition comprising:
a polyvinyl chloride extracted from a waste comprising the polyvinyl chloride;
any one good solvent with a first PVC swelling score value of 0 or less according to the following Equation 1; and any one non-solvent with a second PVC swelling score value of more than 0 according to the following Equation 1:
$$PVC swelling score = {x}_{1} Dipole + {x}_{2} Asphericity + {x}_{3} dH + {x}_{4} Polar Surface Area \qquad [ Equation 1 ]$$
wherein, in Equation 1,
x₁, x₂, x₃, and x₄ are each a real number from 0 to 5,
Dipole is a dipole moment of a solvent molecules,
Asphericity is an asphericity of the solvent molecules,
dH is a Hansen solubility parameter for a hydrogen bonding of the solvent molecules, and
Polar Surface Area is a fractional polar surface area.

13. The waste polyvinyl chloride recycled composition of claim 12, wherein a difference between the first PVC swelling score value of the good solvent and the second PVC swelling score value of the non-solvent is 1.5 or more.

14. The waste polyvinyl chloride recycled composition of claim 12, wherein the good solvent has a boiling point of 85° C. or more.

15. The waste polyvinyl chloride recycled composition of claim 12, wherein the good solvent and the non-solvent each independently comprise any one of an alcohol-based solvent, a ketone-based solvent, an ester-based solvent, an ether-based solvent, a polar nonprotic solvent, a hydrocarbon solvent, or a halogen-containing solvent.

16. The waste polyvinyl chloride recycled composition of claim 12, wherein the good solvent comprises any one of n,n-dimethylacetamide, cyclopentanone, 2-pentanone, dioxane, nitrobenzene, ethylacetate, benzene, trichloroethylene, 1,2-dichloroethane, chloroform, cyclohexanone, tetrahydrofuran, 2-butanone, acetone, 4-methylpentan-2-one, 1,2,3-propanetrioltrinitrate, tetramethylenesulfoxide, 1-piperidinecarboxaldehyde, 1-acetylpiperidine, n-methyl-2-pyrrolidinone, 1,4-dimethylpyrrolidone, 1,3-dimethyl-2-imidazolidinone, 1,5-dimethylpyrrolidone, hexamethylphosphoramide, dimethylpropyleneurea, 1-ethyl-2-pyrrolidone, 1,3-dimethylpyrrolidone, 4-acetylmorpholine, 1-[ethoxy(methyl)phosphoryl]methylpiperidine, n,n-dimethylpropanamide, tributylphosphineoxide, 1-propyl-2-pyrrolidinone, n-isopropylpyrrolidone, n,n,4-trimethylbenzamide, n-methyl-o-acetotoluidide, 2-cyclohexen-1-one, n,n,3-trimethylbenzamide, n,n-dimethylbenzamide, trimethylenesulfide, n,n,2-trimethylbenzamide, 1,3-dioxane, tetramethylurea, 2-azacyclooctanone, 4-methyl-1-propyl-2-pyrrolidinone, 5-methyl-1-propyl-2-pyrrolidinone, n,n-diethylacetamide, 1,3-propanedithiol, 4,5-dihydro-2-methylthiazole, pyrrolidine, 3-methoxy-n,n-dimethylpropanamide, 4-fluoro-n,n-dimethylbenzamide, cycloheptanone, 1-morpholinopentan-1-one, 3-methylcyclohexanone, n,n-dimethylbutanamide, caprolactam, tetrahydrothiophene, 2-methoxy-n,n-dimethylbenzamide, dimethylformamide, 1,2-ethanedithiol, 1,4,7,10-tetraoxacyclododecane, ethyl 1,3-dimethyl-2-oxopyrrolidine-3-carboxylate, 1-(4-methylpiperidyl)butan-1-one, 2-methylcyclohexanone, 1-(2,6-dimethylmorpholin-4-yl)butan-1-one, n,n-diethylformamide, 4-(propan-2-yl)phenyldimethylcarbamate, n,n-dimethyl-3-phenylpropanamide, n-(1-methyl-2-methoxyethyl)-n-chloroacetyl-2-ethyl-6-methylaniline, dichloroacetylchloride, n,n-diethyl-3-(2-methyl-1,3-dioxolan-2-yl)propanamide, n-acetylcaprolactam, d-camphor, n-methylformanilide, ethyl n-acetyl-n-ethyl-beta-alaninate, (2,5-dimethoxyphenyl)acetaldehyde, 4-methylcyclohexanone, 2,6-dimethyl-2,5-cyclohexadiene-1,4-dione, 4-vinylcyclohexene dioxide, nicotine, 2-methylcyclopentanone, dimethylveronal, diethyl(trichloromethyl)phosphonate, 3-methyl-6-isopropylidenecyclohexanone, 1-heptanoyl-4-methylpiperazine, n,n-diethyl-4-oxopentanamide, n-ethyl-n-phenylacetamide, dimethyldisulfide, 4,6-dimethylpyrimidine, 1,4-oxathiane, n-sec-butylpyrrolidone, 1-(4-methylpiperidin-1-yl)pentan-1-one, 1-butyl-5-methyl-2-pyrrolidinone, 3-methyl-2-oxazolidone, n,n-dimethyl-4-(propan-2-yl)benzamide, 2,5-dimethylpyrazine, mesitenelactone, propyl 4-(dimethylamino)-4-oxobutanoate, diethyldimethylamidophosphate, isophorone, n,n-dimethyl 4-methoxybenzamide, 1,2,3,5-tetramethoxybenzene, 3,4,5-trimethoxytoluene, caprolactone, 3-methyl-piperidin-2-one, 2-ethylhexylsalicylate, ethyl 3-ethyl-2-oxooxolane-3-carboxylate, 1-ethyl-3,5,7-trimethyl-1,3-dihydro-azepin-2-one, dimethylisosorbide, cyclotenebutyrate, ethyl 2-(2-methoxyphenoxy)acetate, cyrene, 2,4,4-trimethyl-6-oxocyclohex-1-en-1-yl acetate, 1,2-benzodihydropyrone, tripropyleneglycolethyletherisomer, 3,4-dimethoxypropiophenone, methylaminoacetaldehydedimethylacetal, methyl 2,6-dimethoxybenzoate, 1,3-dimethyl-1,2,3,4-tetrahydro-4-quinolinone, ethyl 3,5-dimethoxybenzoate, 4-methoxybenzaldehyde, ethyl (4-methylphenoxy)acetate, 2,3,4-trimethoxyacetophenone, ethylimidazole, methyl 2-oxocyclooctanecarboxylate, ethyl 2-methyl-4-oxocyclohex-2-enecarboxylate, 2′,5′-dimethoxyacetophenone, isobutylformate, ethyl 2-(2,6-dimethylphenoxy)acetate, ethyl 2-(benzyloxy)acetate, hexylacetoacetate, diethylglutarate, 4-carbethoxy-2-ethyl-3-methyl-2-cyclohexen-1-one, nepetalactone, tripropyleneglycolbutylether, ethyl 5,5-dimethyl-2-oxofuran-3-carboxylate, 2-ethoxybenzaldehyde, methyl-2,4-dimethoxybenzoate, 5,5-diethyl-4-methoxyfuran-2(5H)-one, ethyl 4,6-dimethyl-2-oxo-3,4-dihydro-2h-pyran-5-carboxylate, ethyl 4-phenoxybutanoate, 2,5-dimethoxypropiophenone, ethyl 5,5-dimethyl-2-oxotetrahydrofuran-3-carboxylate, ethyl 3-(5-oxotetrahydrofuran-2-yl)propanoate, benzylsalicylate, n,n-diethyl-4-methyl-4h-pyridine-1-carboxamide, p-tolylacetonitrile, 5-methyl-2(3h)-furanone, 1-methyl-2-(3-pyridyl)pyrrole, formicacidpentylester, ethyl 4-(dimethylamino)benzoate, n-butylacetamide, 4-methylbenzaldehyde, 3′,4′-dimethoxyisobutyrophenone, benzaldehyde, 1,2,4-triethoxybenzene, isobutylphenoxyacetate, m-dimethoxybenzene, 3-oxobutanoicacid-1-methylethylester, ethyl-2-(cyclohexylmethyl)-3-oxobutanoate, 5-ethyldihydro-2(3h)-furanone, 2-isopropyl-n,2,3-trimethylbutyramide, 4-(4-methylpiperidino)pyridine, 3-oxaspiro-undecan-2-one, formicacidhexylester, methyl 2,2-dimethyl-4,6-dioxocyclohexanecarboxylate, ethyl 6-ethyl-2-methyl-4-oxocyclohex-2-ene-1-carboxylate, benzenepropanenitrile, 4,4-dimethyl-5,6,7,8-tetrahydro-1H-isochromen-3-one, ethyl 2,6-dimethyl-4-oxocyclohex-2-enecarboxylate, n,n-dimethyloctanamide, 1-(2,5-dimethylpyrrolidin-1-yl)pentan-1-one, gamma-butyrolactone, t-butylacetoacetate, 4-(methoxymethyl)anisole, mintlactone, 2-methoxyethylacetoacetate, p-(2,2-dimethoxyethoxy)anisole, 1-(1-ethylpropyl)-2-pyrrolizinone, 2,5-dimethoxytetrahydrofuran, 2-acetoxy-1-ethoxypropane, 1,3-dimethyl-4-ethylcarbostyril, 1-(4-methoxyphenoxy)acetone, glycerol tripropionate, 3-dimethylaminoanisole, 2,4-dimethylbenzaldehyde, paraldehyde, glycerol tributyrate, 2,3,4,5-tetramethoxytoluene, 1,3,3-trimethyl-2h-quinolin-4-one, 3-cyclohexene-1-carboxaldehyde, isobutylsalicylate, 2-(1-methylpropyl)phenyl methylcarbamate, (2,2-diethoxyethoxy)benzene, methyl 3-(5-oxooxolan-2-yl)propanoate, 4-acetoxy-2,5-dimethyl-3(2h)-furanone, 3-ethylchroman-2-one, ethyl 3-cyclohexyl-3-oxopropanoate, 1-propyl-2(1h)-pyridinone, 7-methyl-4,4a,5,6-tetrahydro-3H-naphthalen-2-one, 1-(3,5-dimethylphenoxy)propan-2-one, ethyl 3-(2,5,5-trimethyl-1,3-dioxan-2-yl)propanoate, 1-tetralone, 4-methyl-3-penten-2-one, 1-tert-butylpyrrolidin-2-one, methyl 2-(4-(tert-butyl)phenoxy)acetate, 2,6,10,10-tetramethyl-1-oxaspiro(4,5)deca-2,6-dien-8-one, ethyl 4-ethoxybenzoate, maltyl isobutyrate, 4-methyl-1,3-dioxane, 2-acetylpyridine, 1,4-diethoxybenzene, 1-(2,2-diethoxyethoxy)-4-methylbenzene, cyclohexyl lactone, 2-(2-butoxyethoxy)ethyl acetate, n-methylbenzamide, 3-acetyl-5-propyldihydrofuran-2(3h)-one, 2,2-diethoxyethoxymethylbenzene, n-methyl-m-tolylcarbamate, ethylene glycol dibutyrate, 4-cyano-2-fluorobenzoyl chloride, 3,6-dimethyl-2,3,3a,4,5,7a-hexahydro-1-benzofuran-2-one, ethyl 2-(2-oxocyclohexyl)acetate, 4-(2-acetoxyethoxy)toluene, 4-(2,5-dimethylpyrrol-1-yl)-2,6-dimethylmorpholine, 1-butylpyridin-2(1h)-one, n,n-dimethyldecanamid, valeraldehyde, 2-(3-pyridyl)piperidine, 4-methoxypropiophenone, 4-tert-butyl-n,n-dimethylbenzamide, acetylacetone, ethyl 2-methyl-2-phenoxypropanoate, ethyl 2-acetyl-5-oxohexanoate, n-sec-isopentylpyrrolidone, 4-methyl-1-tetralone, 2-butoxyethanolacetate, isobutyric anhydride, n-hexyl-2-pyrrolidinone, 3-benzyl-2,4-pentanedione, ethyl 5-oxodecanoate, methyl 2-hexyl-3-oxocyclopentanecarboxylate, 8-ethyl-1-oxaspiro[4.5]decan-2-one, n,n′-dibutylethyleneurea, methyl 3-oxododecanoate, 3-methyl-5-isopropyl-4-carbethoxy-2-cyclohexene-1-one, 6-pentyl-2h-pyran-2-one, m-methoxyacetophenone, benzisoxazole, n,n-diethylnicotinamide, ethyl 3-(2-oxocyclohexyl)propanoate, propyl 4-ethoxybenzoate, 5-butyl-5-ethyltetrahydro-2h-pyran-2-one, ethyl 2-oxo-1-propylcyclohexanecarboxylate, 2-propoxyethylacetate, dimethyl 2-methylglutarate, o-methylcorypalline, 1-pentylimidazole, n-formylmorpholine, methyl 2-butoxybenzoate, 7-butyloxepan-2-one, propanoic anhydride, acetophenone, 1-(3-methylpiperidin-1-yl)pentan-1-one, 1-butyl-2-methyl-imidazole, anisaldehyd diethyl acetal, 1-(2-methylpiperidin-1-yl)pentan-1-one, 5-butyl-5-ethyloxolan-2-one, 2,4,6-trimethylbenzaldehyde, n,n-diethylcyclohex-3-ene-1-carboxamide, butan-2-yl 4-methoxybenzoate, propylene glycol alpha methylbenzyl ether, 5-(benzyloxy)pentan-2-one, n,n-dimethyldodecanamide, n,n-diethyl-m-toluamide, (s)-dihydrobovolide, 3,4-dihydro-3-oxoedulan, butyl 2-methoxybenzoate, 7-cyclohexyloxepan-2-one, dimethyl 1,4-cyclohexanedicarboxylate, delta-decalactone, ethyl 2,5-dimethylphenoxyisobutyrate, 4a,8-dimethyl-3,4,5,6,7,8-hexahydronaphthalen-2-one, 5-hydroxy-2-decenoic acid lactone, ethyl 2-(2-oxooxolan-3-yl)acetate, methyloctalacton, 3-pentanone, 2,4-diacetylfuran, 2′-pentyloxyacetophenone, furfural, diethylmalonate, 1-(azepan-1-yl)butan-1-one, p-methoxyvalerophenone, n,n-diethylbenzamide, 4,4-dimethylnaphthalen-1(4h)-one, gamma-decalactone, piperitone, ethylacetoacetate, 1-hexylimidazole, dihydromintlactone, 4-heptanone, dimethyl glutarate, 4-(benzyloxy)-4-methylpentan-2-one, 3,3-dimethyl-1-phenoxybutan-2-one, molinate, 7-methoxy-2,2-dimethylchromene, propiophenone, ethyl 2-benzoyl-3-methylbutanoate, n,n-diethyl-2-methylcyclohexane-1-carboxamide, 5-methyl-5-propyl-1,3-dioxan-2-one, 3-methyl-5-(2-oxopropyl)oxolan-2-one, 1-(azepan-1-yl)pentan-1-one, 2-(2-ethoxyethoxy)-ethanolacetate, 2-methyl-1-(1-phenylethyl)imidazole, methyl 6-(diethylamino)-6-oxohexanoate, 5-undecanolide, 4-methyl-5-pentyloxolan-2-one, 2-ethoxyethylbenzoate, 3,4-dihydro-2(1h)-naphthalenone, 1-methoxy-3-(4-methylphenoxy)benzene, n,n-dihexylacetamide, dihydroactinidiolide, 1-pentanoylpiperidine, propan-2-yl 6-(dimethylamino)-6-oxohexanoate, 5,5-dimethyl-4-(3-oxobutyl)oxolan-2-one, 1-octylpyrrolidin-2-one, gamma-undecalactone, 4-ethoxyphenethylacetate, 2-hexanoylcyclohexan-1-one, gamma-methyldecalactone, 1-(azepan-1-yl)-3-methylbutan-1-one, methyl dihydrojasmonate, p-methoxypivalophenone, 2-acetyl-4-tert-butylcyclohexan-1-one, 4,4-dibutyl-gamma-butyrolactone, 4-ethyl-2,6-dimethoxyphenol, n,n-diethylcyclohexanecarboxamide, 5-dodecanolide, 1-hexanoylpiperidine, 1-heptyl-1h-imidazole, 2-isopropoxyethylbenzoate, butanoic anhydride, methylacetoacetate, 2,3,3-trimethylindanone, 5-hexyl-4-methyldihydrofuran-2(3h)-one, phenoxyacetone, 1-propoxy-2-propanol, ethyl di-n-propylthiolcarbamate, 1,2-dimethoxy-4-methylbenzene, tetrahydrofurfurylpropionate, 2-pyrrolidon, 2-methoxypropyl acetate, 4-dodecanolide, 2-ethoxy-4-(methoxymethyl)phenol, n-isopentylpropionanilide, pentylpiperidine-1-carboxylate, 1-(2-ethylpiperidin-1-yl)butan-1-one, isopropyl 2-isopropoxy-benzoate, n,n-dibutylpentanamide, 2,3-dihydro-2,2-dimethyl-7-hydroxybenzofuran, 2-heptanone, 2-[2-(2-methoxypropoxy)propoxy]-1-propanol, 1,2,3,4,5,6,7,8-octahydro-2,8,8-trimethylnaphthalene-2-carbaldehyde, cycloate, 4-methylquinoline, 5-nonanone, n,n-dipentylbutanamide, 3-dimethylamino-2-methylpropiophenone, 2-ethyl-1-pentanoylpiperidine, 4-(ethoxymethyl)-2-methoxyphenol, n,n-dibutylhexanamide, 2-ethylhexyllactate, tripropyleneglycolmonomethylether, magnolione, 1-octylimidazole, butylformate, butylate, 5-ethyl-2-(2-furyl)-4-propyl-m-dioxane, 1-methoxy-4-(2-methoxyethoxymethyl)benzene, hexylpiperidine-1-carboxylate, 4-propylcyclohexanone, 2,5,8,11,14,17-hexaoxaoctadecane, ethyl n,n-diethylsuccinamate, ethyl dipentylcarbamate, 2-butoxyethyl 4-methylbenzoate, 4′-pentylacetophenone, vernolate, 2-cyclopentyl cyclopentanone, 2-butoxyethylbenzoate, trimethoxymethane, phenoyethylpropionate, 4′-isobutylacetophenone, 2-methylindole, n,n,2-triethylhexanamide, 2-methoxy-4-propylphenol, 3,5-bis(2-methylpropyl)cyclohexane-1,2-dione, 2,4-diethoxy-6-methylpyrimidine, ethyl-2-hydroxybenzoate, p-ethoxybenzaldehyde, glycerol triacetate, p-hexylacetophenone, n,n-diisopropyl-phenylacetamide, 3-ethylundecane-4,6-dione, 1-benzazine, methyl 5-methylsalicylate, n,n-dipropylheptanamide, 4-methylpyridine, 4-pentylcyclohexanone, 4-pyridinecarboxaldehyde, oxolan-2-yl methylheptanoate, 2-(2-(4-methylcyclohex-3-enyl)propyl)cyclopentanone, 2-isopropoxyphenol, octanophenon, 2-benzyl-4-methyl-1,3-dioxane, ethylbenzoate, 4-methyl-2-(2-methylpropyl)oxan-4-ol, 3-(diethylamino)propiophenone, benzylacetoacetate, isoamylbenzoate, pyridine, dichloromethane, or 1,1,2,2-tetrachloroethane.

17. The waste polyvinyl chloride recycled composition of claim 12, wherein the non-solvent comprises any one of n-propanol, diethylether, n-heptane, hexane, 1,4-butadiol, octane, cyclopentane, propyleneglycol, dimethylsulfoxide, methanol, ethanol, 2-propanol, 2,4-dimethylhexane, 3-ethyl-2,4-dimethylpentane, 2,7-dimethyloctane, 2,6-dimethyl-heptane, 2-methyl-3-ethylpentane, 3,3-dimethylhexane, 2,3,5-trimethylhexane, 2,3,4-trimethylpentane, 2,2-dimethylheptane, 3,3-dimethylpentane, 1-(perfluorobutyl)icosane, 2,5-dimethylhexane, 2,2-dimethylhexane, 2,3,3-trimethylpentane, formicacid, 2,2,6-trimethylheptane, 2,2,4-trimethylhexane, 2,2,3-trimethylpentane, 2,3,3,4-tetramethylpentane, 2,4,4-trimethylhexane, 1-hydroxybenzotriazole, 3-ethyl-2,2-dimethyl-pentane, 2,2,4,6,6-pentamethylheptane, 2,2,5-trimethylhexane, 2-nitroethanol, 2,2,3,4-tetramethylpentane, octamethyltrisiloxane, 2,2,3,3-tetramethylhexane, 1,5-pentanediol, 1,1,1,2,2,3,3-heptafluoroundecane, 2,2,5,5-tetramethylhexane, 2,2,3,3-tetramethylpentane, 2,2,4-trimethylpentane, 2,2,4,4-tetramethylpentane, dodecamethylcyclohexasiloxane, acetaldehydeammonia, 1,1,1,2,2,3,3,4,4-nonafluorohexadecane, dodecamethylpentasiloxane, 1,1,1,2,2,3,3-heptafluorononane, 1,3-dioxolan-2-one, decamethyltetrasiloxane, 1-(perfluorohexyl)docosane, hexamethyldisilane, 1,1,1,2,2,3,3,4,4,5,5-undecafluorononadecane, tetradecamethylhexasiloxane, 1,1,1,2,2,3,3,4,4,5,5,6,6-tridecafluorohexacosane, 1,1,1,2,2,3,3,4,4-nonafluoroundecane, 1,1,1,2,2,3,3,4,4-nonafluorododecane, hexadecamethylheptasiloxane, 1,1,1,2,2,3,3,4,4,5,5,6,6-tridecafluorotetracosane, propynol, 1,1,1,2,2,3,3,4,4-nonafluorodecane, ethanolamine, 1,1,1,2,2,3,3,4,4,5,5,6,6-tridecafluorodocosane, 2-hydroxypropanenitrile, 1,1,1,2,2,3,3,4,4,5,5,6,6-tridecafluoroicosane, 1,1,1,2,2,3,3,4,4-nonafluorononane, 1,1,1,2,2,3,3,4,4,5,5,6,6-tridecafluorooctadecane, cis-2-butene-1,4-diol, 1,1,1,2,2,3,3,4,4,5-decafluorononane, 1,1,1,2,2,3,3,4,4,5,5,6,6,7,7,8,8-heptadecafluorooctacosane, 1,1,1,2,2,3,3,4,4,5,5,6,6-tridecafluorohexadecane, 1,1,1,2,2,3,3,4,4,5,5,6,6,7,7,8,8-heptadecafluorohexacosane, 1,1,1,2,2,3,3,4,4,5,5,6,6,7,7,8,8-heptadecafluoropentacosane, 1,1,1,2,2,3,3,4,4,5,5,6,6-tridecafluoropentadecane, 1,1,1,2,2,3,3,4,4,5,5,6,6,7,7,8,8-heptadecafluorotetracosane, 1-(perfluorohexyl)octane, 1,1,1,2,2,3,3,4,4,5,5-undecafluorodecane, 1,1,1,2,2,3,3,4,4,5,5,6,6-tridecafluorotridecane, 1,1,1,2,2,3,3,4,4,5,5,6,6,7,7,8,8-heptadecafluorodocosane, 1h,8h-hexadecafluorooctane, 1,1,1,2,2,3,3,4,4,5,5,6,6,7,7,8,8,9,9,10,10-henicosafluorotriacontane, hexacosamethyldodecasiloxane, 1,1,1,2,2,3,3,4,4,5,5,6,6,7,7,8,8-heptadecafluoroicosane, 1,1,1,2,2,3,3,4,4,5,5,6,6-tridecafluorododecane, 1,3-propanediol, 1,1,1,2,2,3,3,4,4,5,5,6,6-tridecafluoroundecane, 1,1,1,2,2,3,3,4,4,5,5,6,6,7,7,8,8-heptadecafluorononadecane, 1,1,1,2,2,3,3,4,4,5,5,6,6,7,7,8,8,9,9,10,10-henicosafluorononacosane, 1,1,1,2,2,3,3,4,4,5,5,6,6,7,7,8,8-heptadecafluorooctadecane, 1,1,1,2,2,3,3,4,4,5,5,6,6,7,7-pentadecafluorotetradecane, 1,1,1,2,2,3,3,4,4,5,5,6-dodecafluorononane, 1,1,1,2,2,3,3,4,4,5,5-undecafluorooctane, 1,1,1,2,2,3,3,4,4,5,5,6,6,7,7-pentadecafluorotridecane, 1-perfluorooctyloctane, 1,1,1,2,2,3,3,4,4,5,5,6,6-tridecafluorodecane, 1,1,1,2,2,3,3,4,4,13,13,14,14,15,15,16,16,16-octadecafluorohexadecane, 1,1,1,2,2,3,3,4,4,5,5,6,6,7,7,8,8-heptadecafluoropentadecane, 1,1,1,2,2,3,3,4,4,5,5,6,6,7,7,8,8,9,9,10,10,11,11,12,12-pentacosafluorohentriacontane, acetamidomethanol, 1,1,1,2,2,3,3,4,4,5,5,6,6,7,7,8,8-heptadecafluorotetradecane, 1-(henicosafluorodecyl)undecane, 1,1,1,2,2,3,3,4,4,5,5,6,6,7,7,8,8-heptadecafluorotridecane, 1,1,1,2,2,3,3,4,4,5,5,6,6,7,7,8,8,9,9,10,10,11,11,12,12-pentacosafluorooctacosane, ethylenecyanohydrin, 1,1,1,2,2,3,3,4,4,5,5,6,6,7,7,8,8,9,9,10,10-henicosafluoroicosane, 1,1,1,2,2,3,3,4,4,5,5,6,6-tridecafluorooctane, perfluorooctylbromide, 1,1,1,2,2,3,3,4,4,5,5,6,6,7,7,8,8,9,9,10,10-henicosafluorooctadecane, 1,1,1,2,2,3,3,4,4,5,5,6,6,7,7,8,8-heptadecafluorododecane, 1,1,1,2,2,3,3,4,4,5,5,6,6,7,7,8,8,9,9,10,10,11,11,12,12-pentacosafluorotetracosane, pentacosafluorotricosane, 1-(perfluorohexyl)propane, 1,1,1,2,2,3,3,4,4,5,5,6,6,7,7,8,8,9,9,10,10-henicosafluoropentadecane, 1,1,1,2,2,3,3,4,4,5,5,6,6,7,7,8,8-heptadecafluorodecane, 1,1,1,2,2,3,3,4,4,5,5,6,6,7,7,8,8,9,9,10,10-henicosafluorotetradecane, 1,1,1,2,2,3,3,4,4,5,5,6,6,7,7,8,8,9,9,10,10,11,11,12,12-pentacosafluorooctadecane, 1,1,1,2,2,3,3,4,4,5,5,6,6,7,7,8,8,9,9,10,10-henicosafluorotridecane, 1,1,1,2,2,3,3,4,4,5,5,6,6,7,7,8,8,9,9,10,10-henicosafluorododecane, glycol, tetratriacontafluorotetracosane, glycerol, 1,1,1,2,2,3,3,4,4,5,5,6,6,7,7,8,8,9,9,10,10,11,11,12,12-pentacosafluorotetradecane, methylhydroperoxide, H₂O, 4-hydroxymethyl-1,3-dioxolan-2-one, hydroxyacetonitrile, perfluorooctane, perfluorodecalin, methanesulfonicacid, formamide, 4-methylphenol, PBr₃, H₂O₂, BBr₃, methylbutane, 2,2-dimethylbutane, 2,2,3-trimethyl-butane, 2,2-dimethylpentane, 2,3-dimethylbutane, pentane, 2,4-dimethylpentane, 2-methylpentane, 2-methylhexane, 3-methylpentane, 3-methylhexane, 3-ethylpentane, 3-ethyl-3-methylpentane, 2-methylheptane, 3,3-diethylpentane, 3-methylheptane, 2-methyloctane, 4-methylheptane, 3-ethylheptane, 2-methyl-nonane, 3-methyloctane, 4-methyloctane, 2-methyldecane, 3-methyl-nonane, 1,1,3,3-tetramethylcyclopentane, 1,3-butanediol, 4-methyldecane, 5-methyl-nonane, 4-methyl-nonane, 1,1-dimethylcyclopentane, 1,1,2-trimethylcyclopentane, 1,1,2-trimethylcyclohexane, n-decane, n-nonane, isobutylcyclopentane, isopropylcyclopentane, tert-butylcyclohexane, pentadecane, tridecane, 1,1,3-trimethylcyclopentane, 1,1,3-trimethylcyclohexane, nonadecane, heptadecane, octadecane, ethylcyclopentane, dodecane, n-undecane, propylcyclopentane, isobutylcyclohexane, isopropylcyclohexane, 1-ethyl-1-methylcyclopentane, 2,3,3-trimethyl-1-butene, 2,4,4-trimethyl-1-pentene, n-hexylcyclopentane, pentylcyclopentane, 1-isopropyl-4-methylcyclohexane, trimethylaluminum, n-tetradecylcyclopentane, tridecylcyclopentane, tetradecane, n-dodecylcyclopentane, n-decylcyclopentane, n-propylcyclohexane, ethylcyclohexane, 3,3-dimethyl-1-butene, n-hexadecane, pentene, 2,3,3-trimethyl-1-pentene, decylcyclohexane, pentylcyclohexane, 3,4-dicyclohexyl-2,5-dimethylhexane, 2-methyl-1-butene, 3,3-dimethyl-1-pentene, 4,4-dimethyl-1-pentene, butylcyclohexane, methylcyclopentane, methylcyclohexane, decahydronaphthalene, hexahydroindene, bicyclohexyl, cyclohexane, 2,4,4-trimethyl-2-pentene, 2,3-dimethyl-1-pentene, tricyclohexylmethane, butylcyclopentane, 1-hexene, 2,3-dimethyl-1-butene, methylformamide, 3,3-dimethyl-1-butyne, triethyleneglycol, 3-methoxy-1,2-propanediol, 2,4-dimethyl-1-pentene, 1-heptene, 3-methyl-1-pentene, 3-ethyl-2-methyl-1-pentene, 1,4-di-tert-butylbenzene, diethyleneglycol, octene, methoxyaceticacid, 1-nonene, 4-methyl-1-hexene, 1,1,3,4,4,6-hexamethyltetralin, 1,3,5-triisopropylbenzene, 1,2,2,6,6-pentamethylpiperidine, 1,4-diethylbenzene, 2-methyl-2-butene, isoprene, 4-methyl-1-pentene, 1-tetradecene, 3-ethyl-1-pentene, 2-methyl-3-heptene, 1-decene, 2,3,4-trimethyl-2-pentene, 1-nonadecene, butylbenzene, 2-ethoxy-2-methyl-propane, 1,2-diethylbenzene, ethanedial, cyclohexylbenzene, galaxolide, 1,2,3,4-tetramethylbenzene, 1,2,3,5-tetramethylbenzene, pentaethylbenzene, 1,3,5-trimethylbenzene, isobutanol, peroxyaceticacid, 1,6-hexanediol, 2,6-di-tert-butyl-4-methylpyridine, 2,2′-(methylimino)bis-ethanol, 1,3-bis(1-methylethyl)-benzene, 2,7-diisopropylnaphthalene, 1,2,3,5-tetraethylbenzene, tetrahydro-2,2,5,5-tetramethylfuran, 1,5-diisopropylnaphthalene, 2,3-butanediol, 1,2-diisopropylbenzene, 1-(2-pentyl)-4-(3-pentyl)benzene, tetradecylbenzene, pentadecylbenzene, ethylbenzene, 3,6-bis-(methoxymethyl)-durene, 5-hydroxy-6-methoxy-8-[(4-amino-1-methylbutyl)amino]quinoline trihydrobromide, 1-(1,1-dimethylethyl)-3-methylbenzene, tridecylbenzene, 1-(methoxymethyl)-4-(2,4,4-trimethylpentan-2-yl)benzene, dodecylbenzene, 1,2,4-trimethylbenzene, 1-cyclohexyl-2-isopropylbenzene, 4,6,6-Trimethylbicyclo(3,1,1)hept-3-en, 2,6-di-tert-butylpyridine, 1,1′-oxybis-octane, 1,5-hexanediol, 1-(1,1-dimethylethyl)-3,5-dimethylbenzene, menthylisovalerate, 1-methyl-7-(1-methylpropyl)naphthalene, tert-butanol, beta-himachalen, dimethoxymethane, 1,2,3,4,5,6,7,8-octahydroanthracene, tert-butylbenzene, 1,2-hexanediol, cyclohexene, 6,10,14-trimethylpentadecan-2-one, delta-cadinene, isopropylbenzene, undecylbenzene, 2,5-hexanediol, dipropyleneglycol, 1,6-dimethyl-4-isopropyltetralin, di-n-propylether, diisopropylether, cuparen, 1,4-bis(1-methylethyl)-benzene, 2,4-dimethyl-3-thiapentane, 1-methoxy-4-(2,4,4-trimethylpentan-2-yl)benzene, 1-ethoxybutane, decylbenzene, or cycloheptane.
